(19) United States
(12) Patent Application Publication
(10) Pub. No.: US 2026/0188894 A1
(43) Pub. Date: Jul. 2, 2026

(54) SYSTEMS AND METHODS FOR A TELEMATICS CONTROL UNIT

(71) Applicant: Harman Becker Automotive Systems, Inc., Novi, MI (US)

(72) Inventors: Xuelin Liu, Kunshan City (CN); Houn Baek, Suwon-si (KR); Toshiyuki Nakanishi, Wixom, MI (US); Yong-Sun Shin, Suwon-si (KR); Havent Chen, Shanghai (CN); Sang-Bong Sung, Seongnam-si (KR); Jinu Kim, Seoul (KR); Dhanaji Khade, Bengaluru (IN); Amine Taleb-Bendiab, Ann Arbor, MI (US)

(21) Appl. No.: 19/294,127

(22) Filed: Aug. 7, 2025

Related U.S. Application Data
(60) Provisional application No. 63/740,932, filed on Dec. 31, 2024.

(51) Int. Cl. H01Q 1/32; H01Q 1/38; H01Q 1/50; H01Q 3/22

(52) U.S. Cl. CPC H01Q 1/32; H01Q 1/38; H01Q 1/50; H01Q 3/22

(57) ABSTRACT

Embodiments are disclosed for an example telematics system for a vehicle. The telematics system includes a reconfigurable antenna including an antenna portion, a coupling portion, a radiation switch, and a frequency switch. The telematics system further includes a plurality of antennas, and a processor with instructions stored in non-volatile memory to link one antenna of the plurality of antennas to the satellite based on a predicted overlap between a stored radiation pattern of the one antenna and a calculated azimuth and elevation angle of the satellite.

### CROSS REFERENCE TO RELATED APPLICATIONS

The present application claims priority to U.S. Provisional Application No. 63/740,932 entitled “SYSTEMS AND METHODS FOR A TELEMATICS CONTROL UNIT”, and filed on Dec. 31, 2024. The entire contents of the above-listed application is hereby incorporated by reference for all purposes.

### FIELD

The disclosure relates to the field of vehicle communication systems, and in particular to telematics control units for a vehicle.

### BACKGROUND

A telematics control unit (TCU) or telematics unit is a system in a vehicle that can wirelessly connect the vehicle to various network services over various types of networks, such as cellular, Wi-Fi, Bluetooth, etc. Such systems can also control wireless tracking, diagnostics, and communication to and from the vehicle, for example. In some examples, a TCU may collect telemetry data from the vehicle, such as position, speed, engine data, connectivity quality, etc., from various sub-systems over data and control busses. Such TCU systems may use antennas to collect and communicate signal data.

A TCU may include one or more antennas, each antenna dedicated to one type of communication network. For example, at least one antenna may be included for each of cellular, Bluetooth/WiFi, and global navigation satellite system (GNSS) and satellite communication (SatCom). Each antenna included in the TCU may add to a cost, weight and size of the TCU. Additionally, each separate antenna may add to the risk of interference cause by coexistence of antennas.

### SUMMARY

The inventors have identified the above problems and embodiments are disclosed herein for at least partially addressing at least some of the problems. The example telematics system comprises a reconfigurable antenna of a telematics unit, comprising: an antenna portion physically coupled to a base; a coupling portion physically coupled to the base; a radiation switch electrically coupled to the coupling portion and configured to switch between electrically coupling to a first short ground and electrically coupling to a first open ground; and a frequency switch electrically coupled to the antenna portion and configured to switch between electrically coupling to a second short ground and electrically coupling to a second open ground.

In an another representation, the example telematics system comprises a plurality of antennas, wherein each of the plurality of antennas is configured to link to a satellite and at least one other communication system; and a processor including instructions stored in non-volatile memory that when executed cause the processor to: link one antenna of the plurality of antennas to the satellite based on a predicted overlap between a stored radiation pattern of the one antenna and a calculated azimuth and elevation angle of the satellite.

### BRIEF DESCRIPTION OF THE DRAWINGS

The disclosure may be better understood from reading the following description of non-limiting embodiments, with reference to the attached drawings, wherein below:

FIG. 1 shows a schematic depicting an example inter-vehicle communications system in accordance with one or more embodiments of the present disclosure;

FIG. 2 shows an example partial view of a vehicle cabin in accordance with one or more embodiments of the present disclosure;

FIG. 3 shows an example in-vehicle computing system in accordance with one or more embodiments of the present disclosure;

FIG. 4 shows a perspective view of an example of a reconfigurable antenna;

FIG. 5 shows top view and a side view of the reconfigurable antenna;

FIG. 6 shows an operating scheme of the reconfigurable antenna;

FIG. 7 shows a photograph of a second example of the reconfigurable antenna;

FIG. 8 shows graphs of voltage standing radio wave (VSWR) as a function of frequency measured for operating modes of the second example of the reconfigurable antenna;

FIG. 9 shows three dimensional plots of signal gain for operating modes of the second example of the reconfigurable antenna;

FIG. 10 shows a flowchart of a method for selecting between modes of the reconfigurable antenna;

FIG. 11 shows a flowchart of an example of a method for linking to a satellite using a telematics control unit using a line of sight module;

FIG. 12 shows a block diagram of a telematics unit including modules for selecting an antenna for linking to a satellite;

FIG. 13 shows an illustration of a telematics unit including a plurality of antennas and radiation patterns of the plurality of antennas;

FIG. 14 shows examples of look up table used for selecting an antenna for linking to a satellite;

FIG. 15 shows a flowchart of an overview of method for selecting an antenna for linking to a satellite;

FIG. 16 shows a flowchart of a method for selecting an antenna for linking to a satellite using a non line of sight module; and

FIG. 17 shows an illustration of satellite and antenna handover.

### DETAILED DESCRIPTION

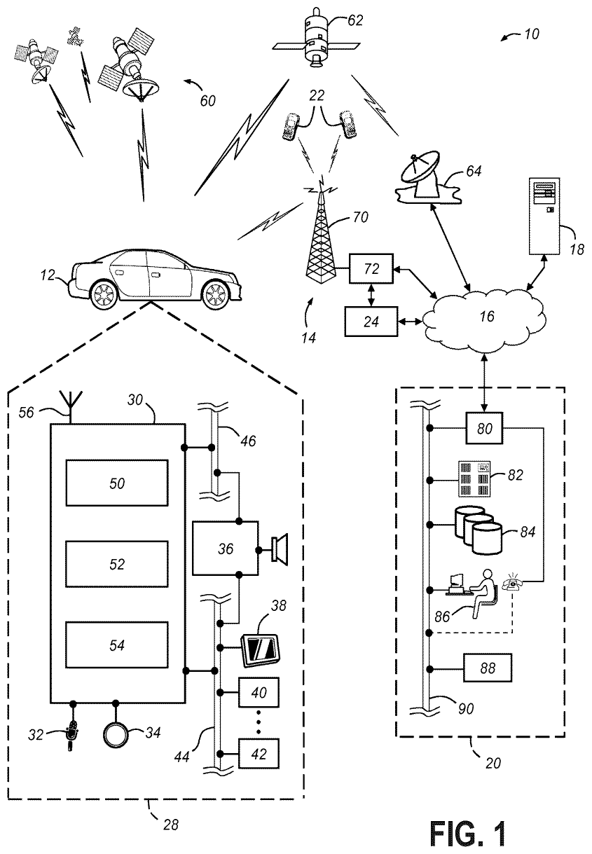

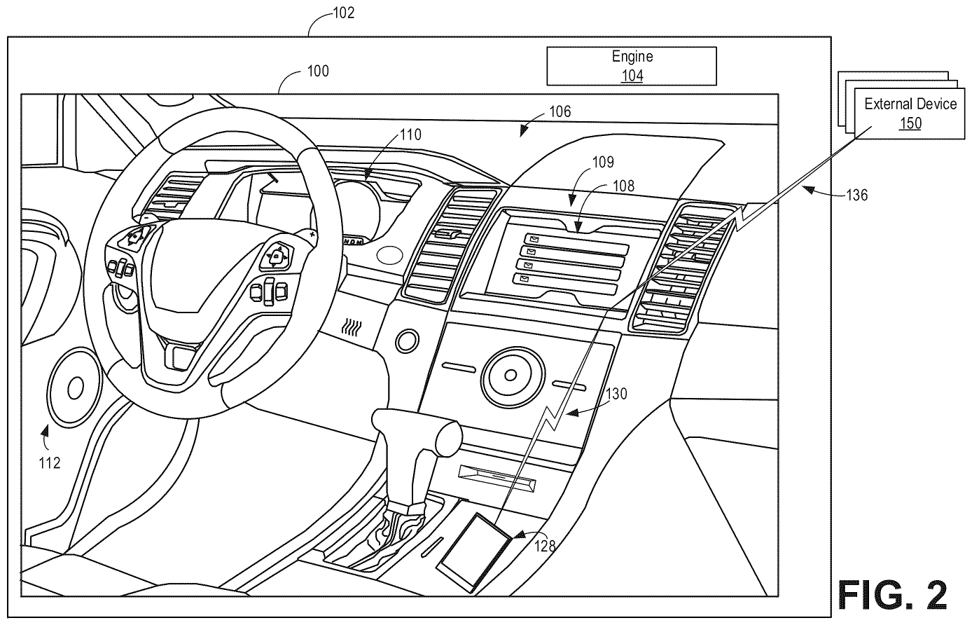

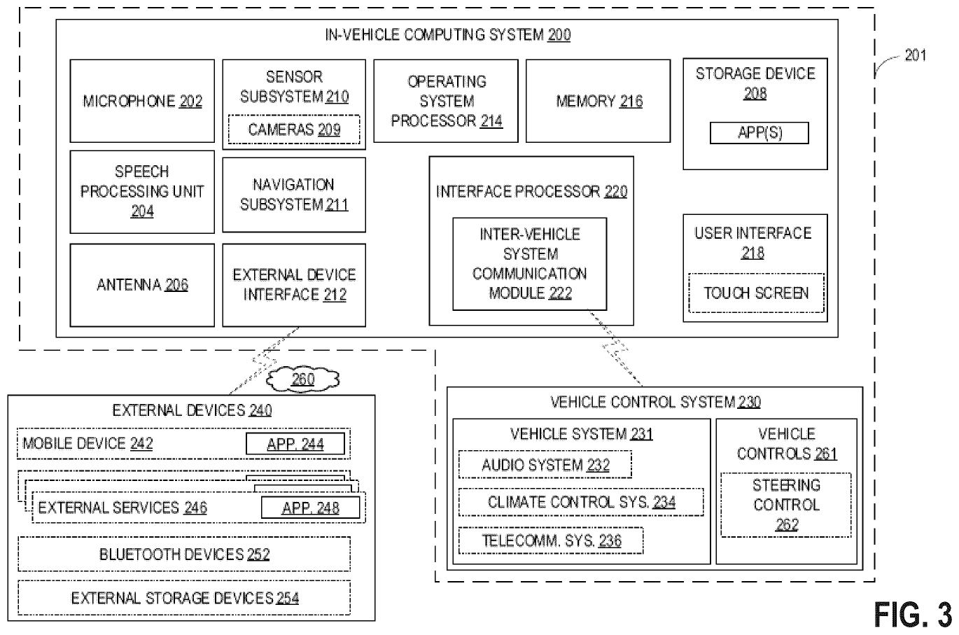

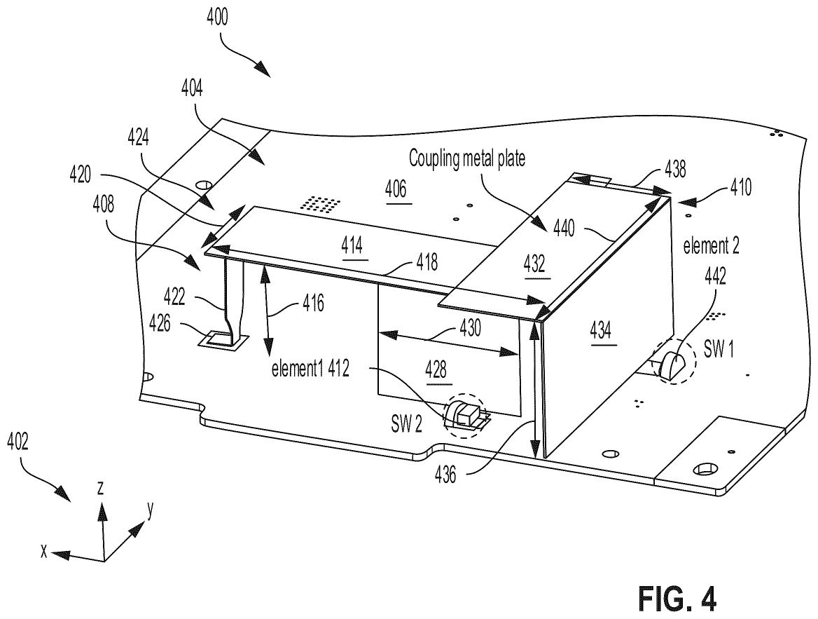

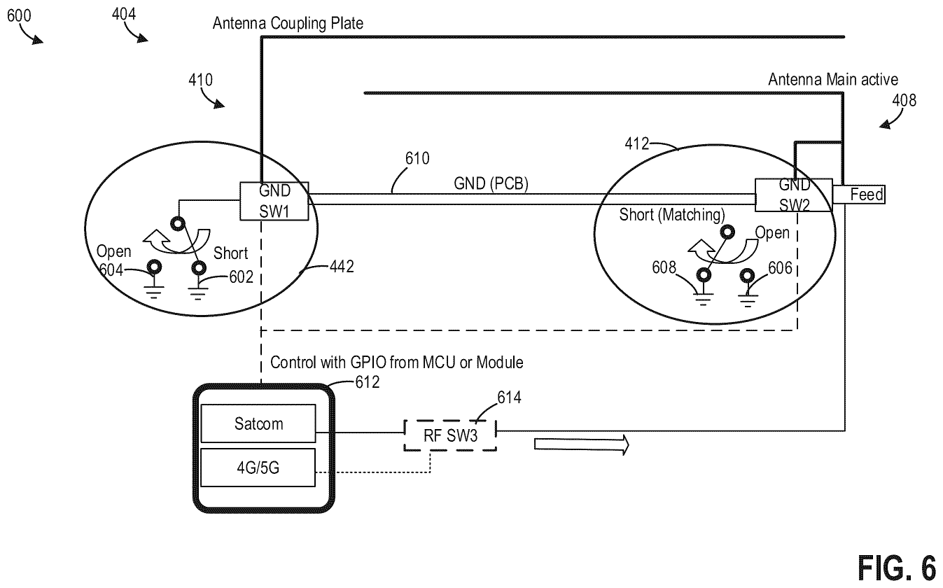

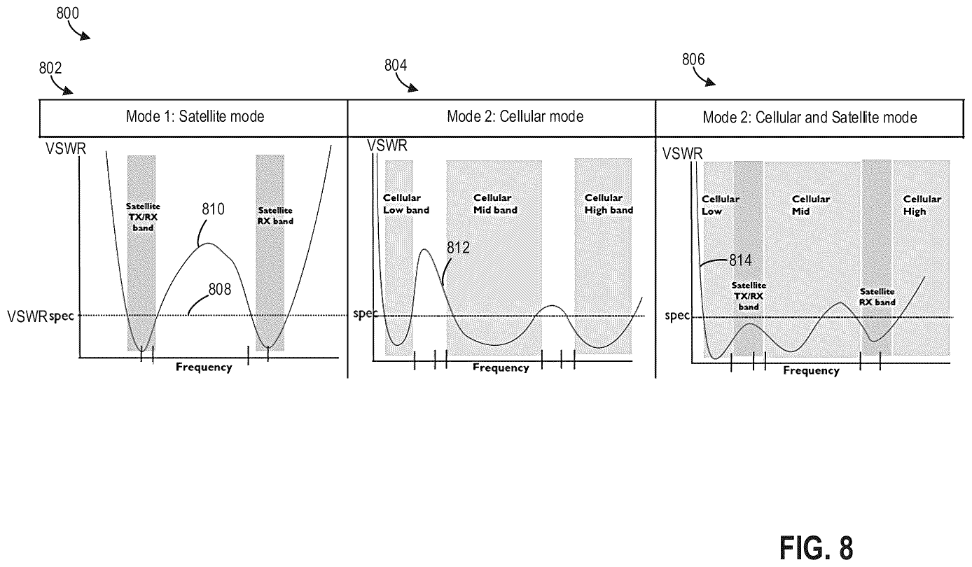

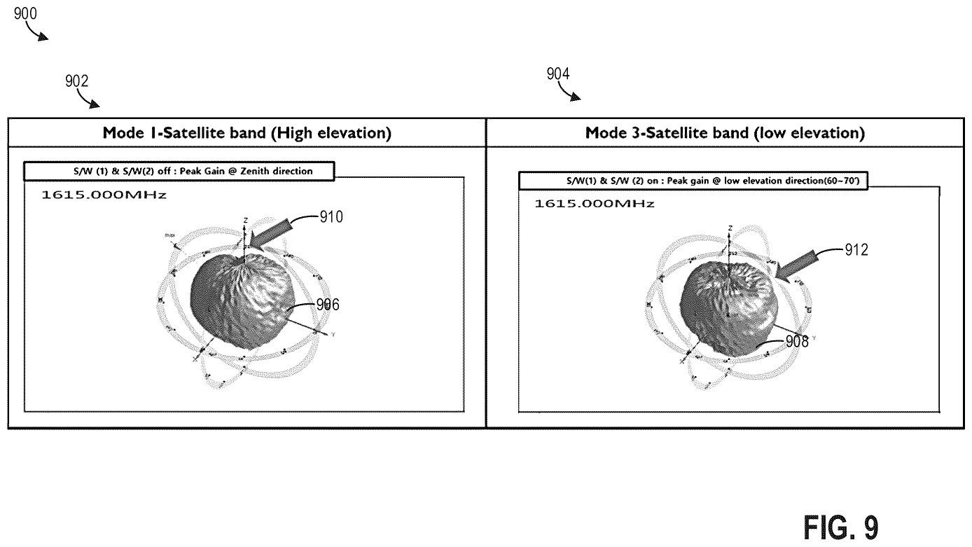

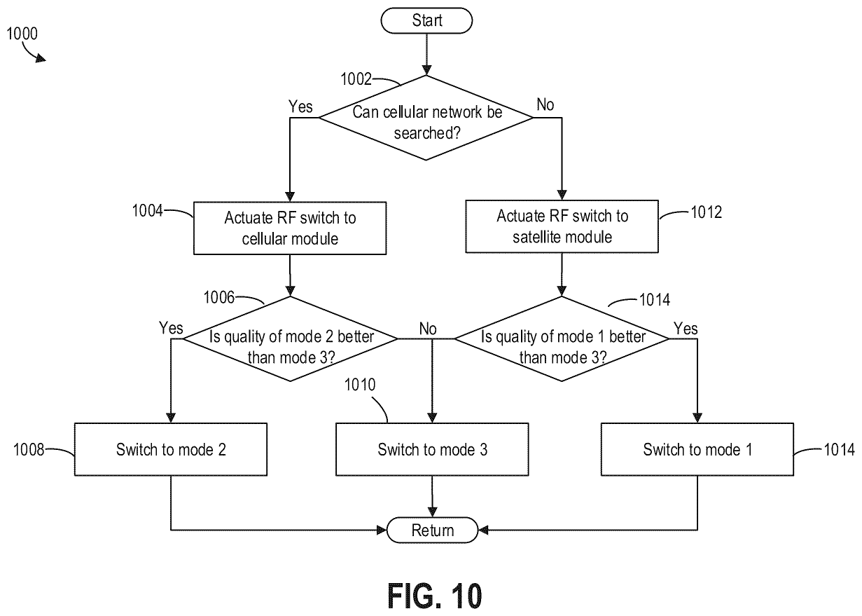

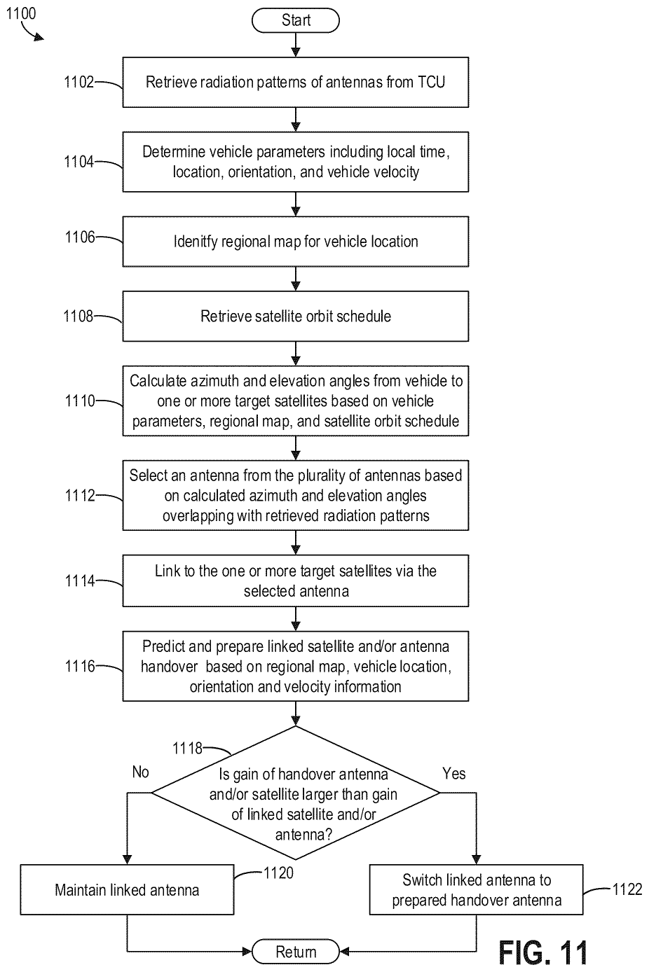

As described above, telematics systems are used to provide telecommunications and cellular connectivity for vehicles. The telematics control unit may be connectable to or integrated with a plurality of antennas. The present disclosure describes a telematics system for a vehicle that reduces a number of antennas included in telematics system and also provides methods that provide a more stable communication link than for conventional telematics systems. In one example, the telematics control unit may include a reconfigurable antenna and may be configured to switch between three operating modes depending on a demanded radiation pattern and communication frequency. In this way, one physical antenna may receive both cellular (e.g., 4G/5G) communication and satellite communication (SatCom). In an alternate example, a dedicated SatCom antenna may be omitted from the telematics unit and a SatCom algorithm may select between the remaining plurality of antennas to perform the function of the SatCom antenna depending on the relative position of the satellite and the vehicle. A communications system, such as the system depicted in FIG. 1, shows one such example of a telematics system capable of providing communication between a vehicle and external services. The telematics system may include a telematics control unit configured as described above. The telematics system may be included in a vehicle, such as the vehicle for which an indoor cabin is shown in FIG. 2. The vehicle may further include a computing system which incorporates the telematics control unit as depicted in the block diagram in FIG. 3. A cost and weight of the telematics control unit may be decreased by decreasing a number of incorporated antennas. A reconfigurable antenna such as the reconfigurable antenna shown in FIGS. 4-5 and 7 may decrease a number of demanded antennas by functioning as both a cellular antenna and a satellite antenna. An operation scheme of the reconfigurable antenna is shown in FIG. 6 and plots demonstrating the flexibility of the frequency and radiation pattern of the reconfigurable antenna are shown in FIGS. 8-9. A method for selecting an optimized mode of the reconfigurable antenna is shown in FIG. 10. A cost and weight of the telematics control unit may be further decreased by a SatCom free telematics unit wherein a plurality of antennas configured to connect to other communication modalities (e.g., cellular, WLAN, GNSS, etc.,) and also used for satellite communication. A method and system for selecting from the plurality of antennas for an optimal antenna for linking to one or more target satellites is shown in FIGS. 11-17.

With reference to FIG. 1, there is shown an exemplary operating environment that comprises an inter-vehicle communications system 10 that can be used to implement the methods disclosed herein. Inter-vehicle communications system 10 generally includes one or more telematics-equipped vehicles 12, one or more wireless carrier systems 14, and one or more remote servers 16. In some examples, the inter-vehicle communications system 10 may additionally include various personal wireless devices 22, and a short message service center (SMSC) 24. It should be understood that the methods disclosed below with reference to FIGS. 11 and 15-16 can be used with any number of different systems and is not specifically limited to the operating environment shown here. Thus, the following paragraphs simply provide a brief overview of one possible configuration for providing wireless communication between each of the vehicles 12, and between the vehicles 12 and remote servers 16. However, it should be appreciated that other systems not shown here could be employed to execute the disclosed methods as well.

Vehicles 12 are depicted in the illustrated embodiment as passenger cars, but it should be appreciated that any other vehicle including motorcycles, trucks, sports utility vehicles (SUVs), recreational vehicles (RVs), marine vessels, aircraft, etc., can also be used. Some of the vehicle electronics 28 are shown generally in FIG. 1. More detailed depictions of example vehicle electronics which may be included in vehicles 12 are shown below with reference to FIGS. 2-3. The vehicle electronics 28 may include one or more of a telematics unit 30 (also referred to as a TCU), a microphone 32, one or more pushbuttons or other control inputs 34, an audio system 36, a visual display 38, and a navigation module 40 as well as a number of vehicle system modules (VSMs) 42. Some of these devices can be connected directly to the telematics unit 30 such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed or aftermarket device that enables vehicles 12 to receive and/or transmit wireless signals corresponding to voice, text, and/or other data. Thus, telematics unit 30 may send and/or receive wireless signals (e.g., electromagnetic waves) such as Wifi, Bluetooth, radio, cellular, and so on. Telematics unit 30 may therefore be referred to as transceiver 30, since it may be capable of both sending and receiving wireless signals. Wireless signals produced by the telematics unit 30 of vehicles 12 may be sent to and received by one or more of the vehicles 12 and remote servers 16. Thus, each of the vehicles 12 may be in wireless communication with one another for sending and/or receiving information there-between via the telematics unit 30. Further, each of the vehicles 12 may be in wireless communication with the remote servers 16 for sending and/or receiving information there-between.

Wireless communication between the remote servers 16 and the vehicles 12 may be maintained even at greater distances between the servers 16 and the vehicles 12 by including relay towers 70. Each of the towers 70 may include sending and receiving antennas for relaying wireless signals between the remote servers 16 and the vehicles 12.

However, it should be appreciated that in some examples, relay towers 70 may not be included in the communications system 10, and that the vehicles 12 may be in direct wireless communication with the remote servers 16. Further, if one or more of the vehicles 12 are separated from the remote server 16 by a sufficient distance, and/or terrain (e.g., mountains) blocks the wireless signal from being transmitted there-between, then the one or more vehicles 12 may not be in wireless communication with the servers 16.

Additionally or alternatively, communications system 10 may utilize satellite communications to provide uni-directional or bi-directional communication between one or more of the vehicles 12 and the remote servers 16. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Further, in some examples, each of the vehicles 12 may wirelessly transmit information to the satellite 62, which broadcasts the information to the servers 16.

As such, each of the vehicles 12 may communicate with one or more of remote server 16, other telematics-equipped vehicles 12, or some other entity or device capable of transmitting and/or receiving wireless signals. Telematics unit 30 enables the vehicle to offer a number of different services including those related to messaging, navigation, telephony, emergency assistance, diagnostics, infotainment, and so on. Data can be sent over a data connection, such as via a packet switching connection, or via a voice channel using techniques already known in the art. For combined services that involve both voice communication and data communication, the system can utilize a single call over a voice channel and switch as needed between voice and data transmission over the voice channel, and this can be done using techniques known to those skilled in the art.

According to one embodiment, telematics unit 30 utilizes a wireless modem 50 for data transmission, an electronic processing device 52 (e.g., processor 52), one or more digital memory devices 54, and one or more antennas 56. It should be appreciated that the modem can either be implemented through software or it can be a separate hardware component located internal or external to telematics unit 30. The modem can operate using any number of different standards or protocols such as EVDO, CDMA, GPRS, and EDGE. Wireless networking between the vehicles 12 and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet switching data communication such as TCP/IP, the telematics unit 30 can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit 30 to provide a wide variety of services. For instance, processor 52 can execute programs or process data to carry out at least a part of the methods discussed herein.

Telematics unit 30 can be used to provide a diverse range of vehicle services that involve wireless communication to and from the vehicles 12. Such services can include: remote control of certain vehicle features through the use of VSMs 42; turn-by-turn directions and other navigation-related services provided in conjunction with the navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the exemplary telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicles 12, to cite but a few possibilities. In the event that the modules are implemented as VSMs 42 located external to telematics unit 30, they could utilize communications bus 44 to exchange data and commands with the telematics unit 30.

In some examples, the antennas 56 of the telematics unit 30 may be integrated with the telematics unit 30. The antennas 56 may be configured for various different signal networks, such as cellular, Wi-Fi, and/or global navigation satellite system (GNSS) signals, for example. The antennas 56 may be configured for terrestrial networks, SatCom networks, and/or NTNs. Narrow Band NTN (NB-NTN) networks use geostationary satellites. NTN is a communication protocol defined by 3GPP™ and may be for forms of non-terrestrial networks including satellite (e.g., LEO, MEO, and GEO), high-altitude platforms, and drones. NTN is non-proprietary. Antennas 56 may also be configured proprietary and non-proprietary NTN. Frequencies used are in L and S band. UE Devices that support NB-NTN use the same cellular antennas that are used for Terrestrial Networks (TN). The same Terrestrial Network antenna switching disclosed herein can be used for NB-NTN. Future NTNs may use low-earth orbit (LEO) satellites and demand separate phased array antennas which allow beam forming and tracking the satellite movement. SatCom may also include communication between antennas 56 and medium earth orbit (MEO) and/or geostationary earth orbit (GEO) satellites. The proposed frequencies for these are in FR2 band from 17 to 30 GHz. In some examples FR2 may be greater than 7 GHz whereas FR1 may be less than 7 GHz. For example, frequency bands L & S may be within FR1 and Ku (12-18) GHz may be within FR2. It is to be appreciated that the antennas 56 may include two or more antennas for each different signal network, at least in some examples.

In one example, antennas 56 may include a reconfigurable antenna. The reconfigurable antenna may be configured for communication to SatCom networks and to cellular networks. For example, as described further in FIGS. 4-10 the reconfigurable antenna may be reconfigurable in terms of both operating frequency band and radiation pattern. The reconfigurable antenna may use two switching elements to realize 3 operating modes: (1) a satellite mode with high elevation with high elevation radiation pattern (2) a cellular mode (3) a cellular/satellite hybrid mode with low elevation radiation pattern. The telematics unit 30 may further include algorithms of signal quality prediction to execute switching between the modes.

In a further example, telematics unit 30 be a SatCom free telematics unit. Each antenna of the SatCom free telematics unit may be configurable for satellite communication. Each antenna of the SatCom free telematics unit may be configured for at least one other type of communication in addition to satellite communication. The SatCom free telematics unit may not include an antenna dedicated only to satellite communication. Instead of a dedicated SatCom antenna, the SatCom free telematics unit may include a SatCom selection algorithm for selecting one of the non-dedicated antennas best configured to communicate with one or more target satellites based on relative positions of the vehicle and the one or more target satellites and known radiation patterns of the plurality of antennas. The SatCom selection algorithm may predict a preferred antenna for satellite communication for a time and place. In some examples, the SatCom selection algorithm may be included in a conventional telematics unit and may increase SatCom signal quality by using both dedicated SatCom antennas in addition to other communication antennas (e.g., cellular, WLAN, GNSS, etc.) for satellite communication.

The antennas 56 may be coupled to the telematics unit 30 via cabling, via an antenna matching circuit, and/or directly. For example, the telematics unit 30 or an antenna matching circuit may be mounted on an interior surface of a metal surface (e.g., a metal roof) of the vehicle, adjacent to an interface with a glass surface where the antenna is attached so that the antenna can be directly coupled to the telematics unit or antenna matching circuit without cabling. The antenna matching circuit may be coupled to the telematics unit via cabling. The antennas may be spaced apart from each by any suitable distance. Antenna matching circuits may comprise rigid printed circuit boards that have impedance matching capabilities.

Navigation module 40 may be configured to support any suitable navigation system such as GPS, GALILEO, GLONASS, IRNSS, etc. In examples, where the navigation module 40 is a GPS navigation module, the module 40 receives signals from a constellation of GPS satellites 60. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of navigation module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote servers 16, for other purposes, such as fleet management.

Apart from the audio system 36 and navigation module 40, the vehicles 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests and perform other functions. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks. According to one embodiment, the ECM is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicles 12, as numerous others are also possible.

Vehicle electronics 28 may also include a number of vehicle user interfaces that provide vehicle occupants with a means of providing and/or receiving information, such as microphone 32, pushbuttons(s) 34, audio system 36, and visual display 38. As used herein, the term “vehicle user interface” broadly includes any suitable form of electronic device, including both hardware and software components, which is located on the vehicles 12 and enables a vehicle user to communicate with or through a component of the vehicles 12. In the description herein a vehicle user may also be referred to simply as a user, and/or a vehicle operator. Microphone 32 provides audio input to the telematics unit 30 to enable the driver or other occupant to provide voice commands and carry out hands-free calling. For this purpose, it can be connected to an on-board automated voice processing unit utilizing human-machine interface (HMI) technology known in the art. The pushbutton(s) 34 allow manual user input into the telematics unit 30 to provide data, response, or control input. Separate pushbuttons can be used for initiating emergency calls versus regular service assistance calls. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel, a pop-up visual display, or a heads-up display reflected off of the windshield, and can be used to provide a multitude of input and output functions. Various other vehicle user interfaces can also be utilized, as the interfaces of FIG. 1 are only an example of one particular implementation.

Remote servers 16 may take the form of a mainframe computer, server computer, desktop computer, laptop computer, tablet computer, home entertainment computer, network computing device, mobile computing device, mobile communication device, gaming device, etc.

Remote servers 16 may include a logic subsystem 82 and a data-holding subsystem 84. Remote servers 16 may optionally include a display subsystem 86, communication subsystem 88, and/or other components not shown in FIG. 1. For example, remote servers 16 may also optionally include user input devices such as keyboards, mice, game controllers, cameras, microphones, and/or touch screens.

Logic subsystem 82 may include one or more physical devices configured to execute one or more instructions. For example, logic subsystem 82 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 82 may include one or more processors that are configured to execute software instructions. Additionally or alternatively, the logic subsystem 82 may include one or more hardware or firmware logic machines configured to execute hardware or firmware instructions. Processors of the logic subsystem 82 may be single or multi-core, and the programs executed thereon may be configured for parallel or distributed processing. The logic subsystem 82 may optionally include individual components that are distributed throughout two or more devices, which may be remotely located and/or configured for coordinated processing. For example, the logic subsystem 82 may include several engines for processing and analyzing data. These engines may be wirelessly connected to one or more databases for processing data received from one or more of the vehicles 12. One or more aspects of the logic subsystem 82 may be virtualized and executed by remotely accessible networked computing devices configured in a cloud computing configuration.

Data-holding subsystem 84 may include one or more physical, non-transitory devices configured to hold data and/or instructions executable by the logic subsystem 82 to implement the herein described methods and processes. When such methods and processes are implemented, the state of data-holding subsystem 84 may be transformed (for example, to hold different data).

Data-holding subsystem 84 may include removable media and/or built-in devices. Data-holding subsystem 84 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 84 may include devices with one or more of the following characteristics: volatile, nonvolatile, dynamic, static, read/write, read-only, random access, sequential access, location addressable, file addressable, and content addressable. In some embodiments, logic subsystem 82 and data-holding subsystem 84 may be integrated into one or more common devices, such as an application-specific integrated circuit or a system on a chip.

It is to be appreciated that data-holding subsystem 84 includes one or more physical, non-transitory devices. In contrast, in some embodiments aspects of the instructions described herein may be propagated in a transitory fashion by a pure signal (for example, an electromagnetic signal) that is not held by a physical device for at least a finite duration. Furthermore, data and/or other forms of information pertaining to the present disclosure may be propagated by a pure signal.

Remote servers 16 may include one or more databases 85 in data-holding subsystem 84 for storing processed requests for assistance, vehicle location data, and vehicle operator preferences.

When included, display subsystem 86 may be used to present a visual representation of data held by data-holding subsystem 84. As the herein described methods and processes change the data held by the data-holding subsystem 84, and thus transform the state of the data-holding subsystem 84, the state of display subsystem 86 may likewise be transformed to visually represent changes in the underlying data. Display subsystem 86 may include one or more display devices utilizing virtually any type of technology. Such display devices may be combined with logic subsystem 82 and/or data-holding subsystem 84 in a shared enclosure, or such display devices may be peripheral display devices.

When included, communication subsystem 88 may be configured to communicatively couple remote servers 16 with one or more other computing devices, such as vehicles 12. Communication subsystem 88 may include wired and/or wireless communication devices compatible with one or more different communication protocols. As non-limiting examples, communication subsystem 88 may be configured for communication via a wireless telephone network, a wireless local area network, a wired local area network, a wireless wide area network, a wired wide area network, etc. In some embodiments, communication subsystem 88 may allow remote servers 16 to send and/or receive messages to and/or from other devices via a network such as the public Internet.

In some examples, the relay towers 70 may be configured as part of a wireless cellular network. In such examples, the communications system 10 may include personal wireless devices 22 which can be, for example, cellular phones or other personal portable devices capable of wireless communication including, for the illustrated embodiment, SMS messaging capability. The devices 22 can communicate with the relay towers 70 to send and receive voice calls, SMS messages, and possibly other communications such as non-speech data for purposes of providing Internet access, weather information, stock information, etc. Further, the telematics unit 30 of each of the vehicles 12 may be capable of sending and/or receiving SMS messages, and phone calls via the cellular network provided by the relay towers 70.

As such, telematics unit 30 may utilize cellular communication according to either GSM or CDMA standards and thus may include a standard cellular chipset for voice communications like hands-free calling.

Further, communications system may include one or more mobile switching centers (MSCs) 72, as well as any other networking components required to connect wireless carrier system 14 with remote servers 16. Each of the relay towers 70 may therefore include sending and receiving antennas and a base station, with the base stations from different cell towers being connected to the MSC 72 either directly or via intermediary equipment such as a base station controller. Wireless carrier system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless carrier systems 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Short message service center (SMSC) 24 is preferably in communication with relay towers 70 and is involved in the communication of SMS messages. SMSC 24 can operate according to a store-and-forward principal; that is, when a first user sends an SMS message that is intended for a second user, the SMS message gets stored at the SMSC until the second user is available to receive it. In other embodiments, the SMSC employs a store-and-forget approach where it only attempts to pass the SMS message along one time. These types of approaches enable users to send and receive SMS messages at any time, even if they are currently on a voice call. It should of course be appreciated that the exemplary representation of SMSC 24 is but one example of a suitable arrangement, as the SMSC could instead be provided according to some other configuration known in the art. In general, SMS messages sent to or from the vehicles 12 or wireless mobile devices 22 are received and/or transmitted by the relay towers 70, and pass through the MSC 72 and SMSC 24 for processing and routing to the remote servers 16.

An example interior of a cabin of one of the vehicles 12 is shown below with reference to FIG. 2.

FIG. 2 shows an example partial view of one type of environment for a communication system for data synchronization: an interior of a cabin 100 of a vehicle 102, in which a driver and/or one or more passengers may be seated. Vehicle 102 may be the same or similar to vehicles 12 described above with reference to FIG. 1. Vehicle 102 of FIG. 2 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a driver (also referred to as the user) of vehicle 102. For example, instrument panel 106 may include a touch screen 108 of an in-vehicle computing system 109 (e.g., an infotainment system), an audio system control panel, and an instrument cluster 110. While the example system shown in FIG. 2 includes audio system controls that may be performed via a user interface of in-vehicle computing system 109, such as touch screen 108 without a separate audio system control panel, in other embodiments, the vehicle may include an audio system control panel, which may include controls for a conventional vehicle audio system such as a radio, compact disc player, MP3 player, etc. The audio system controls may include features for controlling one or more aspects of audio output via speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system 109 may adjust a radio station selection, a playlist selection, a source of audio input (e.g., from radio or CD or MP3), etc., based on user input received directly via touch screen 108, or based on data regarding the user (such as a physical state and/or environment of the user) received via external devices 150 and/or mobile device 128.

In some embodiments, one or more hardware elements of in-vehicle computing system 109, such as touch screen 108, a display screen, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of the in-vehicle computing system may be modular and may be installed in multiple locations of the vehicle.

The cabin 100 may include one or more sensors for monitoring the vehicle, the user, and/or the environment. For example, the cabin 100 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin 100, etc. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, etc. Information regarding ambient conditions of the vehicle, vehicle status, or vehicle driver may also be received from sensors external to/separate from the vehicle (that is, not part of the vehicle system), such as sensors coupled to external devices 150 and/or mobile device 128.

Cabin 100 may also include one or more user objects, such as mobile device 128, that are stored in the vehicle before, during, and/or after travelling. The mobile device 128 may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct Near-Field Communication [NFC], cellular connectivity, etc.) and configured to provide two-way communication between the mobile device and the in-vehicle computing system. The mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 130 may provide sensor and/or control signals from various vehicle systems (such as vehicle audio system, climate control system, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, navigation system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding contextual data, user behavior/preferences, operating rules, etc. and may transmit such information from the external devices 150 to in-vehicle computing system 109 and touch screen 108.

In-vehicle computing system 109 may analyze the input received from external devices 150, mobile device 128, and/or other input sources and select settings for various in-vehicle systems (such as climate control system or audio system), provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150.

In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

FIG. 3 shows a block diagram of an in-vehicle computing system 200 configured and/or integrated inside vehicle 201. In-vehicle computing system 200 may be an example of in-vehicle computing system 109 of FIG. 2 and/or may perform one or more of the methods described herein in some embodiments. In some examples, the in-vehicle computing system may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 201 in order to enhance an in-vehicle experience for a driver and/or a passenger.

The in-vehicle computing system 200 may be configured to detect the occurrence of an accident, impact, or mechanical failure of vehicle 201 based on input received from the various sensors of vehicle 201. Further, in some examples, a vehicle user, may be able to signal that an impact, accident, mechanical failure, etc., has occurred via user inputs such as buttons, touch screen, etc., of user interface 218.

In-vehicle computing system 200 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an inter-vehicle system communication module 222.

Inter-vehicle system communication module 222 may output data to other vehicle systems 231 and vehicle control elements 261, while also receiving data input from other vehicle components and systems 231, 261, e.g. by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine controller area network [CAN] bus through which engine related information may be communicated, a climate control CAN bus through which climate control related information may be communicated, and a multimedia data network through which multimedia data is communicated between multimedia components in the vehicle). For example, the in-vehicle computing system may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 200 to store data such as instructions executable by processors 214 and 220 in non-volatile form. The storage device 208 may store application data to enable the in-vehicle computing system 200 to run an application for connecting to a cloud-based server and/or collecting information for transmission to the cloud-based server (e.g., remote servers 16 shown in FIG. 1). The application may retrieve information gathered by vehicle systems/sensors, input devices (e.g., user interface 218), devices in communication with the in-vehicle computing system (e.g., a mobile device connected via a Bluetooth link), etc. In-vehicle computing system 200 may further include a volatile memory 216. Volatile memory 216 may be random access memory (RAM). Non-transitory storage devices, such as non-volatile storage device 208 and/or volatile memory 216, may store instructions and/or code that, when executed by a processor (e.g., operating system processor 214 and/or interface processor 220), controls the in-vehicle computing system 200 to perform one or more of the actions described in the disclosure.

A microphone 202 may be included in the in-vehicle computing system 200 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 200 may also be able to receive voice commands and sample ambient vehicle noise using a microphone included in an audio system 232 of the vehicle.

One or more additional sensors may be included in a sensor subsystem 210 of the in-vehicle computing system 200. For example, the sensor subsystem 210 may include a camera, such as a rear view camera for assisting a user in parking the vehicle and/or a cabin camera for identifying a user (e.g., using facial recognition and/or user gestures). Sensor subsystem 210 of in-vehicle computing system 200 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system 200 may generate and/or receive navigation information such as location information (e.g., via a GPS sensor and/or other sensors from sensor subsystem 210), route guidance, traffic information, point-of-interest (POI) identification, and/or provide other navigational services for the driver.

External device interface 212 of in-vehicle computing system 200 may be coupleable to and/or communicate with one or more external devices 240 located external to vehicle 201. While the external devices are illustrated as being located external to vehicle 201, it is to be understood that they may be temporarily housed in vehicle 201, such as when the user is operating the external devices while operating vehicle 201. In other words, the external devices 240 are not integral to vehicle 201. The external devices 240 may include a mobile device 242 (e.g., connected via a Bluetooth, NFC, WIFI direct, or other wireless connection) or an alternate Bluetooth-enabled device 252. Mobile device 242 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. For example, the external storage devices 254 may include servers 16 described above with reference to FIG. 1.

As such, external storage devices 254 may receive requests for assistance from the in-vehicle computing system 200. Operating system processor 214 may determine whether an impact, accident, mechanical and/or electrical failure, occupant medical emergency, of other type of emergency has occurred based on outputs received from the vehicle sensors. Additionally or alternatively, a vehicle driver or passenger may communicate a need for assistance to the operating system processor 214 via the user interface 218. In response to a determination that an impact, accident, mechanical failure, or other emergency has occurred the operating system processor 214 may transmit a request for assistance to the external storage devices 254.

The external storage devices 254 may process the request and determine the desired recipients of the assistance request. In some embodiments, the storage devices 254 may transmit the assistance request to vehicle located in the same geographic area, or within a threshold distance of the vehicle from which the assistance request was received so that nearby vehicles may assist the vehicle. Further, the storage devices 254 may contact external services 246 such as ambulances, tow trucks, police, etc., to provide the desired assistance to the vehicle.

External devices 240 may communicate with in-vehicle computing system 200 either wirelessly or via connectors without departing from the scope of this disclosure. For example, external devices 240 may communicate with in-vehicle computing system 200 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the driver. For example, the external device interface 212 may enable phone calls to be established and/or text messages (e.g., SMS, MMS, etc.) to be sent (e.g., via a cellular communications network) to a mobile device associated with a contact of the driver. The external device interface 212 may additionally or alternatively provide a wireless communication interface to enable the in-vehicle computing system to synchronize data with one or more devices in the vehicle (e.g., the driver's mobile device) via WIFI direct, as described in more detail below.

One or more applications 244 may be operable on mobile device 242. As an example, mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 244 to external device interface 212 over network 260. In addition, specific user data requests may be received at mobile device 242 from in-vehicle computing system 200 via the external device interface 212. The specific data requests may include requests for determining where the user is geographically located, an ambient noise level and/or music genre at the user's location, an ambient weather condition (temperature, humidity, etc.) at the user's location, etc. Mobile device application 244 may send control instructions to components (e.g., microphone, etc.) or other applications (e.g., navigational applications) of mobile device 242 to enable the requested data to be collected on the mobile device. Mobile device application 244 may then relay the collected information back to in-vehicle computing system 200.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, etc.), data from an internet query (e.g., weather data, POI data), etc. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers. Vehicle audio system 232 may be passive or active such as by including a power amplifier. In some examples, in-vehicle computing system 200 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 201. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 200, such as via communication module 222. The control elements of the vehicle control system may be physically and permanently positioned on and/or in the vehicle for receiving user input. In addition to receiving control instructions from in-vehicle computing system 200, vehicle control system 230 may also receive input from one or more external devices 240 operated by the user, such as from mobile device 242. This allows aspects of vehicle systems 231 and vehicle controls 261 to be controlled based on user input received from the external devices 240.

In-vehicle computing system 200 may further include an antenna 206.

Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via radiofrequency (RF) such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 240 (such as to mobile device 242) via external device interface 212. Antenna 206 is a non-limiting example of an antenna of antennas 56.

One or more elements of the in-vehicle computing system 200 may be controlled by a user via user interface 218. User interface 218 may include a graphical user interface presented on a touch screen, such as touch screen 108 of FIG. 2, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 200 and mobile device 242 via user interface 218. In addition to receiving a user's vehicle setting preferences on user interface 218, vehicle settings selected by in-vehicle control system may be displayed to a user on user interface 218. Notifications and other messages (e.g., received messages), as well as navigational assistance, may be displayed to the user on a display of the user interface. User preferences/information and/or responses to presented messages may be performed via user input to the user interface.

It should be appreciated that the telematics unit 30 as described hereinabove with regard to FIG. 1 may be formed from multiple components of the in-vehicle computing system 200, including but not limited to the antenna 206 and the external device interface 212.

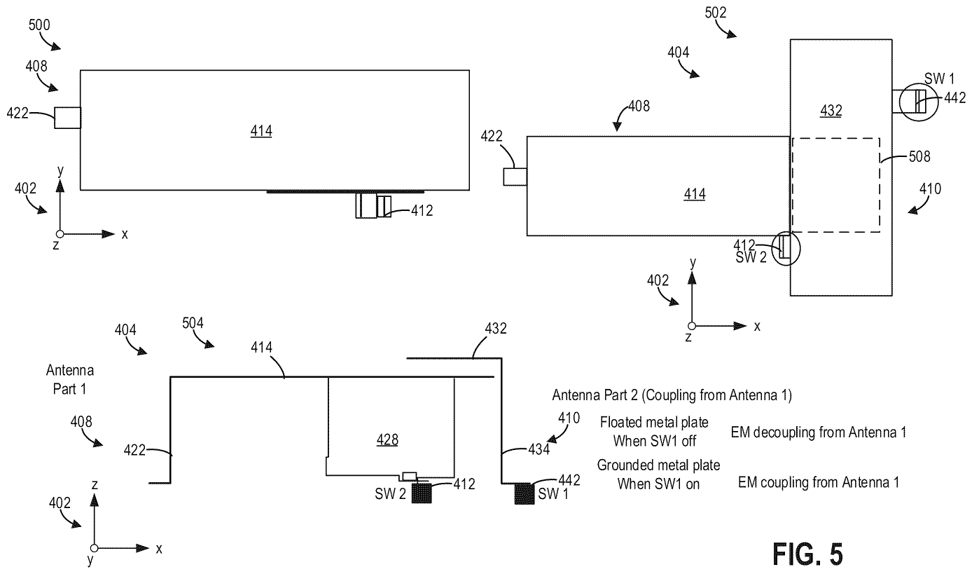

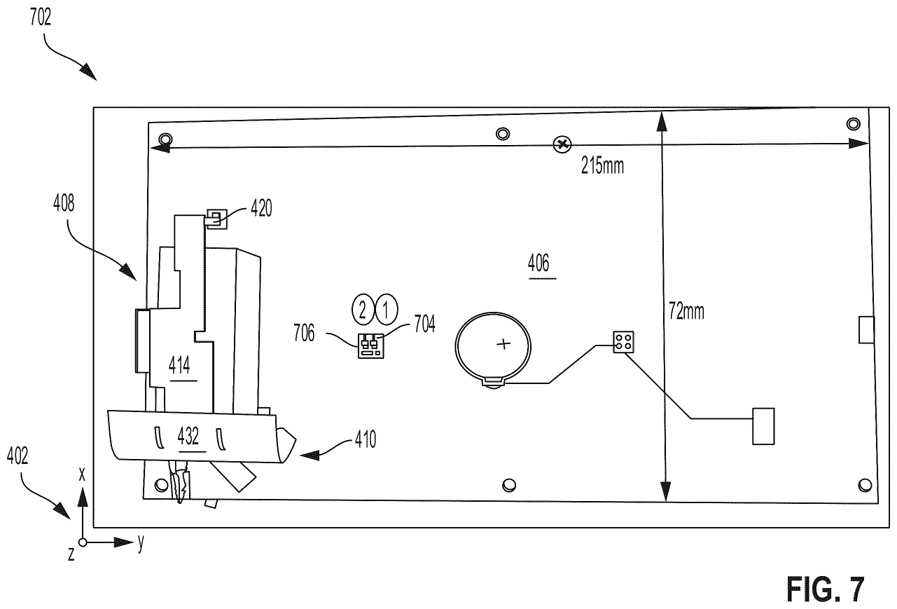

Turning now to FIG. 4 an illustration 400 of reconfigurable antenna 404 including a base 406 is shown. Base 406 may be integrated with a telematics units such as telematics unit 30 described above and reconfigurable antenna 404 may be an example of antennas 56 as described above. A reference axis 402 is provided for comparison of the perspective view in FIG. 4 and the top and side views shown in FIGS. 5 and 7. Reference axis 402 includes an x axis, z axis, and y axis. The z axis may be parallel to a vertical axis and may also be parallel to a gravitational axis when the reconfigurable antenna 404 is positioned on or within a roof of a vehicle. The x axis may be parallel to a longitudinal axis and the y axis may be parallel to a lateral axis.

Reconfigurable antenna 404 may be configured as a planar inverted-f antenna (PIFA) with a coupling plate. Reconfigurable antenna 404 may include an antenna portion 408 and a coupling portion 410. Antenna portion 408 may be a PIFA antenna coupled to a frequency switch 412. Frequency switch 412 may include lumped elements to ground.

Antenna portion 408 may further include a plate portion 414. Plate portion 414 may be positioned parallel to base 406 and spaced away by a vertical distance 416. Plate portion may be a longitudinal length 418 and a lateral length 420. A pin portion 422 of antenna portion 408 may be coupled at a first end to plate portion 414 and at a second end to base 406. The second end may be in a relatively negative z-direction from the first end. Pin portion 422 may extend vertically between plate portion 414 and base 406. Pin portion 422 may be coupled to plate portion 414 at a first longitudinal end 424 of plate portion 414. Pin portion 422 may be bent at substantially 90° at the second end to form a continuous portion 426 of pin portion 422 that is parallel to base 406 and provides a larger surface area for mechanically coupling pin portion 422 to base 406. Continuous portion 426 may protrude a distance past the first longitudinal end 424 of plate portion 414.

Antenna portion 408 may further include a feed portion 428. Feed portion 428 may extend vertically from a longitudinal edge of plate portion 414 towards base 406. A vertical height of feed portion 428 may be equivalent to the vertical distance 416 between plate portion 414 and base 406. Feed portion 428 may extend a longitudinal length 430 along the longitudinal edge of plate portion 414. Frequency switch 412 may be physically coupled to base 406 and to feed portion 428. Frequency switch may be electrically coupled to antenna portion 408. In one example, frequency switch 412 may be physically coupled to feed portion 428 and positioned longitudinally off-center with respect to longitudinal length 430. In alternate examples, a physical position of frequency switch 412 may be spaced away from antenna portion 408. Frequency switch 412 may be configured to adjust impedance matching of reconfigurable antenna 404.

Coupling portion 410 may be L-shaped and may include a parallel plate portion 432 and perpendicular plate portion 434. Coupling portion 410 may be positioned at a second longitudinal end of plate portion 414, opposite the first longitudinal end 424 along the x-axis. A portion of parallel plate portion 432 may be overlapping in the x-y plane with a portion of plate portion 414. Parallel plate portion 432 may be spaced away from plate portion 414 in the vertical direction. The overlapping portion may be at the opposite end of plate portion 414 from pin portion 422 and may be laterally offset along the y-axis with respect to a lateral edge of parallel plate portion 432.

Parallel plate portion 432 may be positioned parallel to base 406 and spaced away from base 406 by a vertical distance 436. Parallel plate portion 432 may be a longitudinal length 438 and a lateral length 440. Longitudinal length 438 of parallel plate portion 432 may be shorter than longitudinal length 418 of plate portion 414. Lateral length 440 of parallel plate portion 432 may be longer than lateral length 420 of plate portion 414. In this way, plate portion 414 and parallel plate portion 432 may be elongated in direction normal to each other (e.g., parallel with the x- and y-axes, respectively). Vertical distance 436 of parallel plate portion 432 may be taller than vertical distance 416 of plate portion 414.

Perpendicular plate portion 434 may extend vertically from base 406 to parallel plate portion 432. Coupling portion 410 may be one continuous part bent at substantially 90° to form the L-shape including the perpendicular plate portion 434 and parallel plate portion 432. Perpendicular plate portion 434 may laterally extend a lateral length 440 along base 406 and may be a vertical height equivalent to vertical distance 436. A radiation switch 442 may be positioned on base 406 and may be physically and electrically coupled to perpendicular plate portion 434. In some examples, radiation switch 442 may be electrically coupled to coupling portion 410 and physically spaced away from coupling portion 410. Radiation switch 442 may be configured to control a radiation pattern shape by adjusting peak gain direction.

FIG. 5 shows as top view 500 of antenna portion 408, a top view 502 of reconfigurable antenna 404 including antenna portion 408 and coupling portion 410, and a side view 504 of reconfigurable antenna 404 along the x-axis. Parts are labeled the same as in FIG. 4 and are not reintroduced.

Comparing top view 500 of antenna portion 408 and top view 502 of reconfigurable antenna 404, an overlapping portion of antenna portion 408 and coupling portion 410 is illustrated. As shown in top view 502, parallel plate portion 432 may extend laterally over plate portion 414 until substantially even along the longitudinal axis with frequency switch 412. The overlapping portion of plate portion 414 and parallel plate portion 432 is indicated by box 508. An area of box 508 may be adjusted to adjust an amount of coupling between antenna portion 408 and coupling portion 410. In this way, frequencies and radiation patterns generated by reconfigurable antenna 404 may be adjusted.

As shown in side view 504, coupling portion 410 may be spaced apart physically from antenna portion 408. Coupling portion 410 may not be directly physically coupled to antenna portion 408. As further shown in side view 504, parallel plate portion 432 may overhang plate portion 414. In this way, when radiation switch 442 is electrically floated (e.g., in an OFF position) coupling portion 410 may be electromagnetically decoupled from antenna portion 408. When radiation switch 442 is electrically grounded to a common base (e.g., base 406) to place radiation switch 442 in an ON position, coupling portion may be electromagnetically coupled to antenna portion 408.

FIG. 6 shows an operating diagram 600 for reconfigurable antenna 404.

Radiation switch 442 may be configured to switch between electrically coupling to a first short ground 602 (e.g., a shorted configuration) and a first open ground 604 (e.g., an open configuration). Frequency switch 412 may be configured to switch between electrically coupling to a second short ground 608 and a second open ground 606. A common ground 610, such as printed circuit board, may electrically couple radiation switch 442 to frequency switch 412. Common ground 610 may be an example of base 406 as described above.

A controller 612 may be communicatively coupled to both frequency switch 412 and radiation switch 442. In one example, controller 612 may be a general purpose input/output (GPIO) of a microcontroller unit (MCU) or other module. In one example, the MCU may be a processor of a telematics unit, such as processor 52 of telematics unit 30 as shown in FIG. 1. A radiofrequency switch 614 may be communicatively coupled to controller 612 and electrically coupled to antenna portion 408. Radiofrequency switch 614 may be in a radiofrequency path and configured to select between a satellite module and a cellular module of reconfigurable antenna 404. Selection of a module (e.g., SatCom or cellular) may communicate to a controller of the telematics unit to configure other hardware and/or software features for communication via the selected modality. In an alternate example, a quadrature-carrier modulation (QCM) may be implemented, and the radiofrequency switch may be incorporated into a network access device of the telematics unit, such as wireless modem 50 of FIG. 1.

Table 1 below shows the modes of a reconfigurable antenna, such as reconfigurable antenna 404 and the corresponding state of a frequency switch, such as frequency switch 412 and a radiation switch, such as radiation switch 442.

TABLE 1
Reconfigurable antenna operation modes

| | | | | ANT performance config. | |
|---|---|---|---|---|---|
| | | Switch Status | | | Rad. |
| | Description | Rad. | Freq. | Freq. VSWR | Pattern |
| 1 | Satellite mode w/ | Open | Open | Satellite band | Zenith/high |
| | high elevation | | | | elevation |
| | radiation pattern | | | | |
| 2 | Cellular mode | Short | Open | Cellular band | Low |
| | | | | | elevation |
| 3 | Cellular & satellite | Short | Short | Cellular and | Low |
| | mode with low | | | satellite band | elevation |
| | elevation radiation | | | | |
| | pattern | | | | |

As shown in Table 1, the reconfigurable antenna may be operated in three different modes according configurations of the frequency switch and the radiation switch. Modes may be numbered 1-3 as shown in Table 1 for reference. The radiation switch may be used for controlling peak gain direction (e.g., radiation pattern shape) adjusting a status of the radiation switch (e.g., ON/OFF or Short/Open) adjusts whether the coupling plate (e.g., coupling portion 410) is working or not working and may also effect impedance of the reconfigurable antenna. The frequency switch may be used to tune (e.g., adjust) the frequency of the reconfigurable antenna into a demanded frequency band for communication. The frequency switch is used for impedance matching (VSWR) in the demanded frequency band. When the radiation switch is open and the frequency switch is open, the reconfigurable antenna may be in a satellite mode with a high elevation radiation pattern (e.g., satellite mode or mode 1). The VSWR frequency may be in a satellite band and the radiation pattern may point to towards a zenith. When the radiation switch is shorted and the frequency switch is open the reconfigurable antenna may be in a cellular mode (e.g., mode 2). In the cellular mode, the radiation pattern may be in the low elevation pattern as the coupling plate is working (e.g., Open) and the VSWR frequency may be shifted to a cellular band. When the radiation switch is shorted and frequency switch is shorted, the reconfigurable antenna may be in a cellular and satellite mode with low elevation radiation patterns (e.g., cellular/satellite hybrid mode or mode 3). The VSWR frequency may overlap both cellular and frequency bands the and radiation pattern may correspond to low elevations.

In one example, radiation switch 442 may controlled by applying power to the radiation switch 422. When power is applied, radiation switch 442 may be in an ON state and the ON state may correspond to radiation switch 442 being shorted (e.g., coupled to first short ground 602). When power is not applied to the radiation switch 442, the radiation switch 422 may be in an OFF state and the OFF state may correspond to the radiation switch 422 being open (e.g., coupled to first open ground 604). In a further example, the frequency switch 412 may stay powered on and may be controlled by a voltage applied to the frequency switch 412. When the applied voltage is low the frequency switch 412 may be open (e.g., coupled to second open ground 606). When applied voltage is high, the frequency switch 412 may be shorted (e.g., coupled second short ground 608). In alternate examples, the switch mechanism (e.g., power and voltage) may be swapped between the frequency switch 412 and the radiation switch 422. In further examples, the switch mechanism is not particularly limited and may use other signals to actuate switching between a short ground and an open ground.

FIG. 7 shows a top down photograph of an alternate example of a reconfigurable antenna 702. Reconfigurable antenna 702 may include some of the same components as reconfigurable antenna 404. Such components are numbered the same and are not reintroduced. As one example, base 406 may be shaped as a rectangle and may be 215 mm in the lateral direction and 72 mm in the longitudinal direction. Antenna portion 408 and coupling portion 410 of reconfigurable antenna 702 may be positioned towards a corner of base 406.

Reconfigurable antenna 702 may include a radiation switch 704 and a frequency switch 706. Radiation switch 704 may operate the same as radiation switch 442 and frequency switch 706 may operate the same as frequency switch 412 as described above with respect to FIG. 6. Radiation switch 704 may be electrically coupled to and physically spaced away from coupling portion 410. Frequency switch 706 may be electrically coupled to and physically spaced away from antenna portion 408. Radiation switch 704 and frequency switch 706 may not be directly physically coupled to antenna portion 408 or to coupling portion 410.

The reconfigurable antenna 702 was tested in the three different operating modes described above in table 1. Graphs 800 of FIG. 8 show VSWR as a function of frequency for the three different modes. A line 808 corresponds to an upper threshold VSWR, below which the frequency is considered matching.

A first graph 802 includes plot 810 corresponding to reconfigurable antenna 702 in a satellite mode (e.g., mode 1) wherein the frequency switch is off (e.g., open) and the voltage applied to the radiation switch is low (e.g., open). Plot 810 includes two valleys, a first valley centered around a satellite TX/RX communication band and a second valley centered around the satellite RX band. The satellite TX/RX band may be, for example, in a range of 1 GHz to 2 GHz. The satellite Rx and may be, for example, in a range of 2 GHz to 3 GHz. In this way the frequency output of the reconfigurable antenna in the satellite mode is well suited to communicating with a satellite.

A second graph 804 includes a plot 812 corresponding to reconfigurable antenna 702 in a cellular mode (e.g., mode 2) wherein the frequency switch is on (e.g., shorted) and the voltage applied to the radiation switch is low (e.g., open). Plot 812 includes three valleys. A minimum of the first valley corresponds to the cellular low band. The second valley is below the VSWR threshold line 808 in range corresponding with the cellular mid band. A minimum of the third valley corresponds with the cellular high band. In on example, the cellular low band may be below (e.g., lower frequency than) the satellite TX/RX band. Further, the cellular mid band may be between the satellite TX/RX band and the satellite RX band. Additionally, the cellular high band may be above (e.g., higher frequency than) the satellite RX band. In this way the frequency output of the reconfigurable antenna in the cellular mode is well suited to communicating on cellular communication frequencies.

A third graph 806 includes a plot 814 corresponding to reconfigurable antenna in combined cellular/satellite hybrid mode (e.g., mode 3) wherein the frequency switch is on (e.g., shorted) and the voltage applied to the radiation switch is high (e.g., shorted). Plot 814 includes three valleys. The first valley is positioned within the cellular low band. The second valley is positioned within the cellular mid band frequency range. Plot 814 is below the VSWR threshold line 808 between the first minimum and the second minimum indicating there is also matching to the satellite TX/RX band. The third valley corresponds to the satellite RX band. Plot 814 is also below the VSWR threshold line 808 extending into the cellular high band frequency range. In this way, switching between the three modes as discussed above may reconfigure a reconfigurable antenna, such as reconfigurable antenna 702 or 404 based on a demanded frequency.

Turning now to FIG. 9, three dimensional plots 900 show radiation patterns measured for reconfigurable antenna 702. A first graph 902 includes a surface 906 corresponding to reconfigurable antenna 702 in mode 1. As discussed above, mode 1 may include low voltage applied to the radiation switch (e.g., open), thereby causing a high elevation radiation pattern. A second graph 904 includes a surface 908 corresponding to reconfigurable antenna 702 in mode 3. As discussed above mode 3 may include a high voltage applied to the radiation switch (e.g., closed), thereby causing a low elevation radiation pattern. Surface 906 shows a maximum gain parallel to the zenith direction as indicated by arrow 910 (e.g., 90° from the x-y plane). In contrast, surface 908 shows a maximum gain at an angle to the zenith direction (e.g., 60°-70° from the x-y plane) as indicated by arrow 912. In this way mode 1 may better overlap with a signal from a high elevation satellite and reconfigurable antenna 702 may be switched to mode 3 to better overlap with a low elevation satellite.

Turning now to FIG. 10, a flowchart of a method 1000 for controlling a reconfigurable antenna, such as reconfigurable antenna 404 or reconfigurable antenna 702 which are described above, is shown. Method 1000 may select a configuration (e.g., mode 1, 2, or 3) of the reconfigurable antenna based on predicting signal quality. Instructions of method 1000 and additional methods described herein may be stored in non-volatile memory of a controller, such as digital memory 54 of telematics unit 30 as described in reference to FIG. 1 and may be executed by a processor such as processor 52.

At 1002, method 1000 determines if the cellular network can be searched. Determining if the cellular network can be searched includes determining if the telematics unit can search for and find a cellular signal. Searching may be performed by a cellular signal monitoring hardware device of the telematics unit configured to continuously monitor a cellular signal strength (e.g., SINR/RSRP). Determining if the cellular network can be searched may occur when the cellular signal monitoring hardware measures a signal strength and compares the signal strength to a threshold. A signal strength above the threshold level indicates the cellular network can be searched. A signal strength below the threshold may cause the cellular signal monitoring hardware device to output a signal indicating there is no cellular network or service and indicates the cellular network cannot be searched. If method 1000 determines the cellular network can be searched, method 1000 proceeds to 1004 and includes actuating an RF switch to configure the reconfigurable antenna to a cellular module. The RF switch may be an example of radiofrequency switch 614 shown in FIG. 6.

At 1006, method 1000 determines if the signal quality of mode 2 (e.g., cellular mode) is better than the signal quality of mode 3 (e.g., cellular/satellite mode). In one example, comparing signal quality as in step 1006 may include monitoring a received signal and comparing the received signal to the frequency/radiation patterns associated with mode 3 and mode 2. The monitored signal may be compared to determine which of the two modes has better signal quality. Metrics of signal quality compared may include signal to noise ratio, received signal strength indicator, and the like. If at 1006, method 1000 determines mode 2 has better signal quality, method 1000 proceeds to 1008 and includes switching to mode 2 (e.g., the cellular mode). Switching to mode 2 may include actuating a frequency switch (e.g., frequency switch 706 or frequency switch 412) to be coupled to a short ground. For example, switching to mode 2 to may include providing power to the frequency switch. Additionally, switching to mode 2 may include actuating a radiation switch (e.g., radiation switch 704 or radiation switch 442) to be coupled to an open ground. Coupling the radiation switch to the open ground may include applying a low voltage to the radiation switch. Further, switching to mode 2 and other switching steps of method 1000 may be performed by implementing an algorithm to prevent hysteresis between reconfigurable antenna modes. Method 1000 returns.

If at 1006 method 1000 determines mode 2 does not have better signal quality than mode 3, method 1000 proceeds to 1010 and includes switching to mode 3 (e.g., cellular/satellite low elevation mode). Switching to mode 3 may include actuating the frequency switch to be coupled to a short ground as described above. Additionally, switching to mode 3 may include actuating the radiation switch to be coupled to a short ground. Coupling the radiation switch to a short ground may include applying a high voltage to the radiation switch. Method 1000 returns.

Returning to 1002, if method 1000 determines that a cellular network cannot be searched, method 1000 proceeds to 1012 and includes actuating the RF switch to the satellite module. At 1014, method 1000 determines if the signal quality of mode 1 is better than the signal quality of mode 3. Comparing the signal quality of mode 1 and mode 3 may occur similarly to comparing mode 2 to mode 3 as described above with respect to step 1006. Additionally, when the RF switch is actuated to a satellite module, comparing signal quality may include using vehicle information such as location, time and heading in addition to a stored satellite orbit schedule and a stored radiation pattern of mode 1 and mode 3 to predict which mode best communicates with a target satellite. An algorithm for selecting an antenna for communication with a satellite is described further below with respect to FIG. 11.

If method 1000 determines the quality of mode 1 is better than the quality of mode 3, method 1000 proceeds to 10018 and includes switching to mode 1. Switching to mode 1 may include actuating the frequency switch to be coupled to an open ground. Coupling the frequency switch to an open ground may include cutting voltage to the frequency switch. Additionally, switching to mode 1 may include actuating the radiation switch to couple to an open ground as discussed above with respect to step 1008. If method 1000 determines the quality of mode 1 is not better than the quality of mode 3, method 1000 proceeds to step 1010 and includes switching to mode 3. Method 1000 returns.

In some examples, the telematics unit, such as telematics unit 30 may be a SatCom free telematics unit as described above with respect to FIG. 1, and either the SatCom free telematics unit or a telematics unit including one or more dedicated SatCom antennas may include a predictive SatCom algorithm as described further below.

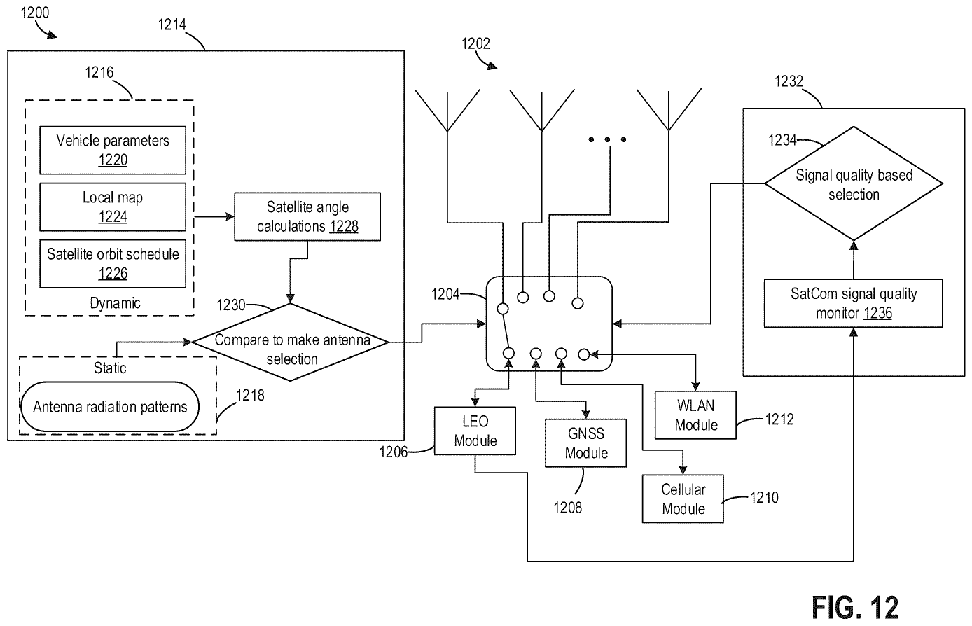

FIG. 12 shows a block diagram of a portion of telematics unit 1200 including the predictive SatCom algorithm. Telematics unit 1200 may be an example of telematics unit 30 of FIG. 1. Telematics unit 1200 may include a plurality of antennas 1202. In one example, the telematics unit 1200 may be a SatCom free telematics unit and each of the plurality of antennas 1202 may be used for more than one communication modality. In an alternate example the plurality of antennas may include dedicated SatCom antennas such as high elevation and low elevation SatCom antennas.

The plurality of antennas 1202 may be electrically coupled to a switch controller 1204. Switch controller 1204 may be configured to selectively couple an antenna of the plurality of antennas 1202 to a module of the telematics unit 1200. Modules may include a low earth orbit (LEO) SatCom module 1206 (e.g., LEO module), a GNSS module 1208, a cellular module 1210, and a WLAN module 1212. Switch controller 1204 may selectively couple an antenna of the plurality of antennas 1202 in response to a command from the telematics unit controller (e.g., processor 52) based on a predictive SatCom algorithm including a line of sight (LOS) decision module 1214 and a no line of sight (NLOS) decision module 1232.

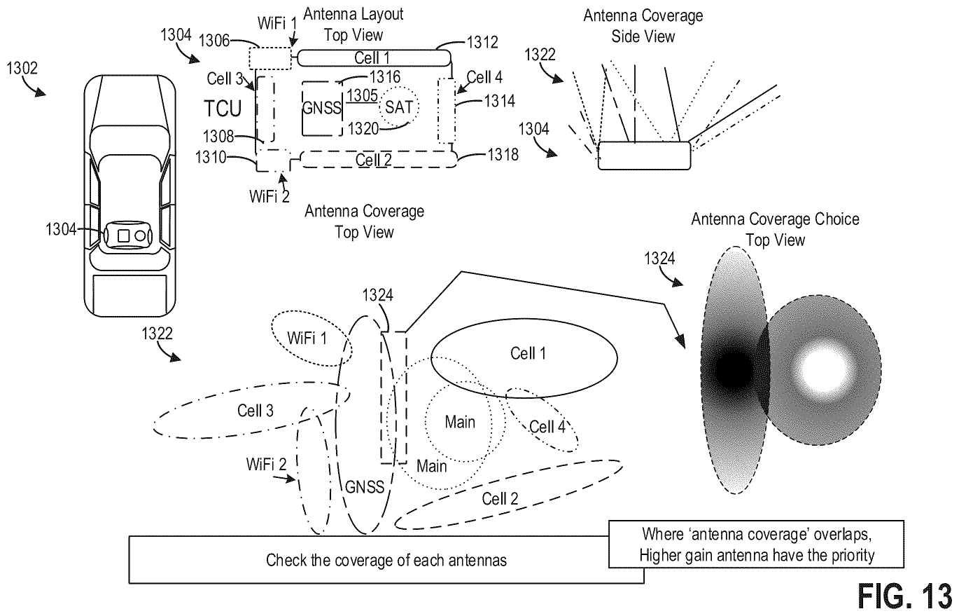

The LOS decision module 1214 may receive dynamic information 1216. Dynamic information 1216 may be received from other sensors and controllers of the vehicle communicatively coupled to telematics unit 1200. Dynamic information 1216 may include vehicle parameters 1220. Vehicle parameters 1220 may include information related to the vehicle including vehicle location, local time, vehicle orientation and vehicle velocity. Dynamic information 1216 may further include a local map 1224 and a satellite orbit schedule 1226. Satellite orbit schedule 1226 may include identity of satellites (e.g., a manufacturer of the satellite), and corresponding local times, positions, and velocities for the identified satellite. The LOS decision module 1214 may further include static information 1218. Static information 1218 may be stored in non-volatile memory of telematics unit 1200. Static information 1218 may include antenna radiation patterns. Information of antenna radiation patterns is described further below with respect to FIG. 13.

Dynamic information 1216 may be inputs of a satellite angle calculation 1228. Satellite angle calculation 1228 may output an elevation angle and an azimuth angle from the vehicle to one or more target satellites. The satellite angle calculation 1228 output may be compared with the static information 1218 at comparison 1230 to select an antenna of the plurality of antennas to link to the one or more target satellites. Comparison 1230 may match an antenna best able to communicate with the one or more target satellites. The selected antennas may be communicated to switch controller 1204.

In the event that the vehicle is not in line of sight of a satellite (e.g., under tree cover), the telematics unit 1200 may select an antenna using NLOS decision module 1232. NLOS decision module 1232 may include a SatCom signal quality monitor 1236. SatCom signal quality monitor 1236 may be hardware communicatively coupled to LEO module 1206 configured to monitor a signal quality of the connection between the one or more target satellites and each antenna of the plurality of antennas 1202. SatCom signal quality monitor 1236 may be included in the telematics unit 1200 or alternatively, communicatively coupled to the telematics unit 1200. Signal quality may be monitored by, for example, monitoring a signal to noise (SNR) and/or reference signal received power (RSRP). The SatCom signal quality monitor 1236 may output a signal quality based selection 1234 and output the selection to the switch controller 1204.

Turning now to FIG. 13, it shows diagrams of a vehicle 1302 including a telematics unit 1304. Telematics unit 1304 may be an example of telematics unit 1200 including the predictive SatCom algorithm as described above with respect to FIG. 12. Telematics unit 1304 may, for example, be positioned on or within a roof of vehicle 1302 towards the rear (e.g., with respect to a normal direction of travel) end. A top view of the telematics unit 1304 shows that a plurality of antennas (e.g., plurality of antennas 1202) may be physically positioned on a rectangular base 1305 of the telematics unit. For example, a first Wi-Fi antenna 1306 and a second Wi-Fi antenna 1310 may be positioned on opposite edges of base 1305. A first cellular antenna 1312, a second cellular antenna 1318, a third cellular antenna 1314, and fourth cellular antenna 1308 may be positioned on each of the four edges of base 1305. In inner portion of base 1305 may include a GNSS antenna 1316. Optionally telematics unit 1304 may include one or more dedicated SatCom antennas 1320. It may be appreciated that a telematics unit including the predictive SatCom algorithm may not demand the one or more dedicated SatCom antennas 1320 and omitting the one or more dedicated SatCom antennas 1320 may reduce a cost, size, and weight of telematics unit 1304.

A side view and top view of telematics unit 1304 shows radiation coverage 1322 of each of the plurality of antennas. Each antenna of the plurality of antennas may cover a different area and angle. A box 1324 highlights an area where radiation coverage for two different antennas may overlap. In examples where antenna coverage overlaps, the antenna having the radiation pattern with the higher gain may have priority.

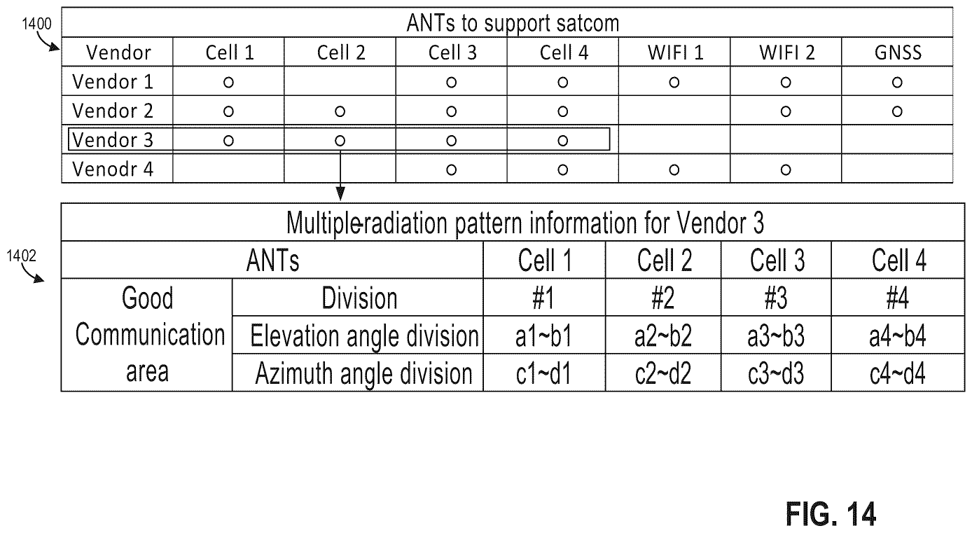

The plurality of radiation patterns exhibited by the plurality of antennas as shown in FIG. 13 may be used to populate one or more lookup tables stored in non-volatile memory of the telematics unit (e.g., telematics unit 1200 and/or 1304). An example of lookup tables is shown in FIG. 14.

A first lookup table 1400 may include rows corresponding to communication satellite vendors (e.g., manufacturers such as Skylo™ or SpaceX™) to which the telematics unit may link. Columns of first lookup table 1400 may include columns corresponding to each antenna of the telematics unit. First lookup table 1400 indicates which antennas support communication over the frequency bands used by each of the satellite vendors. For example, as shown in the example of first lookup table 1400, Vendor 3 may support communication over the frequencies covered by a first, second, third, and fourth cellular antenna but not by the Wi-Fi or GNSS antennas.

A second lookup table 1402 may be stored for each vendor. Second lookup table 1402 may include rows corresponding to elevation angle and azimuth angle and columns corresponding to each antenna which supports communication with the satellite vendor of the table. For example, second lookup table 1402 is for vendor 3 and includes columns for the first, second, third, and fourth cellular antennas. A division (e.g., range) of possible elevation angles and azimuth angles may be assigned to each antenna for which there is the best gain. The best gain may be determined by the amount of physical overlap between the radiation pattern of the antenna and the possible angles of the satellite.

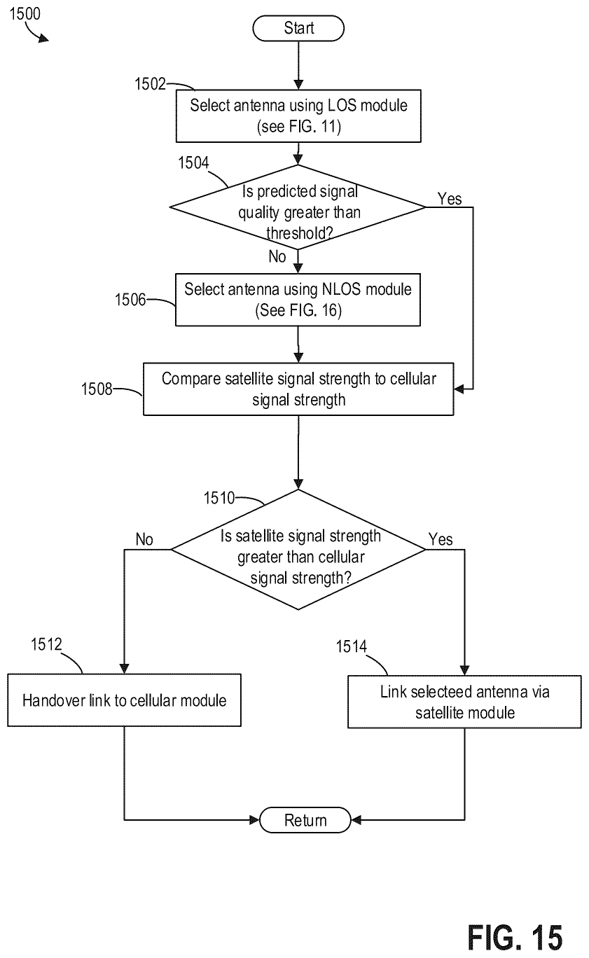

Turning now to FIG. 15, a flow chart of general method 1500 of the predictive SatCom algorithm is shown. Method 1500 may be executed in response to a communications link.

At 1502, method 1500 includes selecting antenna using an LOS module (e.g., LOS decision module 1214). An example of a method executed by the LOS module is shown in FIG. 11 and discussed further below.

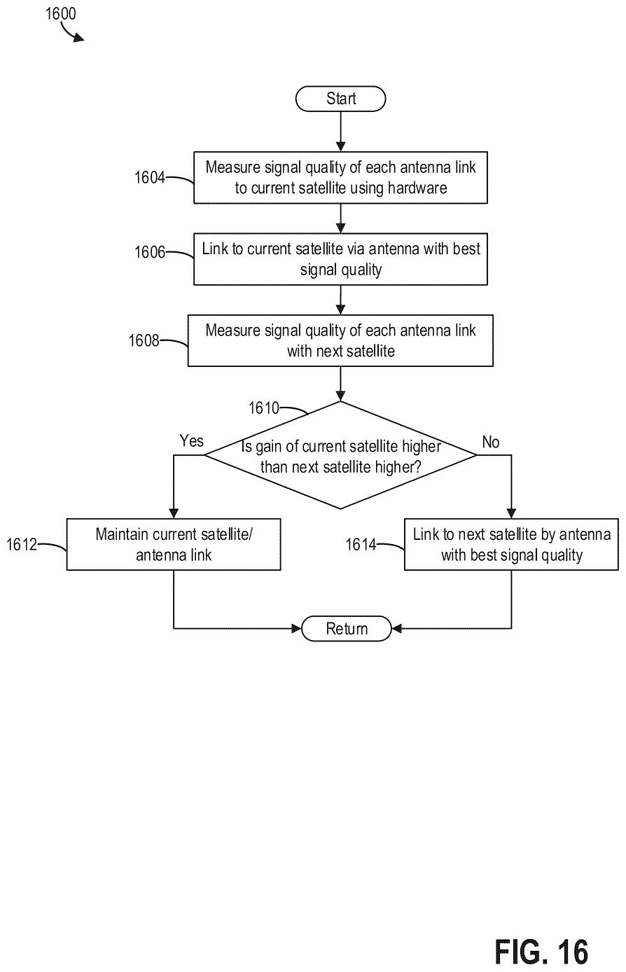

At 1504, method 1500 determines if the signal quality is greater than a signal quality threshold. The signal quality may be determined by a hardware configured to continuously monitor a signal quality of the SatCom link (e.g., SatCom signal quality monitor 1236). As one example a quality of the signal quality may be identified by a quantitative metric such as signal to noise ratio, RISS or the like. If method 1500 determines that the signal quality is not greater than the threshold (e.g., the signal quality is degraded), method 1500 proceeds to 1506 and includes selecting an antenna using the NLOS module (e.g., NLOS decision module 1232). An example of a method executed by the NLOS module is shown in FIG. 16 and discussed further below. If method 1500 determines that the signal quality is greater than the threshold (e.g., the signal quality is not degraded), method 1500 continues selecting the antenna using the LOS module and proceeds to 1508.

At 1508, method 1500 includes comparing a predicted satellite signal strength to a cellular signal strength. The predicted satellite signal strength may be determined as part of selecting the antenna by either the LOS module or the NLOS module. Additionally, signal strength parameters (e.g., signal to noise ratio) may be continuously monitored for each cellular antenna of the telematics unit. The signal strength parameters may be used to predict the cellular signal strength for the cellular antennas.

At 1510, method 1500 determines if the satellite signal strength is greater (e.g., stronger) than the cellular signal strength. If method 1500 determines that the satellite signal strength is not greater than the cellular signal strength, method 1500 proceeds to 1512 and includes handing over the communication link to a cellular module (e.g., cellular module 1210). If method 1500 determines that the satellite signal strength is greater than the cellular signal strength, method 1500 proceeds to 1514 and includes linking the selected antenna to the satellite module (e.g., LEO module 1206). Method 1500 returns.

FIG. 11 shows a flowchart of a method 1100 of a LOS module for selecting a SatCom antenna from a plurality of antennas included in a telematics unit (e.g., telematics unit 1200) when a line of sight is present between the vehicle and satellites. Method 1100 may be executed in response to a user requesting a communications link and method such as method 1500 determining that a line of sight is present.

At 1102, method 1100 includes retrieving radiation patterns of each antenna of the plurality of antennas included in the telematics unit. A radiation pattern for each antenna of the plurality of antennas may be stored in a look-up table on non-volatile memory of the telematics unit (e.g., lookup table shown in FIG. 14 and discussed above). The lookup tables may provide antennas operating at frequencies corresponding to vendors of satellites and for each vendor may include tables for selecting an antenna for a range of elevation and azimuth angles. In examples where an antenna of the plurality of antennas is a reconfigurable antenna, the look-up table may include a radiation pattern for each mode of the reconfigurable antenna.

As 1104, method 1100 includes determining vehicle parameters including local time, location, orientation, and vehicle velocity. Determining vehicle parameters may include communicating with sensors or subsystems of the vehicle, such as, but not limited to sensor subsystem 210 and navigation subsystem 211 as described above with respect to FIG. 3. In some examples, one or more vehicle parameters may be data outputs communicated to and stored in an in-vehicle computing system (such as in-vehicle computing system 200) and communicated to the telematics unit.

At 1106, method 1100 includes identifying a regional map for the vehicle location. The vehicle location may be the vehicle location determined at 1104. Identifying a regional map may include comparing geographical coordinates of the vehicle determined at 1104 with coordinates encompassed by one of a plurality of maps stored in the non-volatile memory of the telecom unit. The regional map may include topographical information. The regional map may be retrieved periodically based on location of the vehicle and dynamically updates based on positioning region.

At 1108, method 1100 includes retrieving a satellite orbit schedule. The satellite orbit schedule may be stored on the non-volatile memory of the telematics unit. The satellite orbit schedule may include orbit schedules of satellites to which the telematics unit may couple. The satellite orbit schedule may be periodically updated over time and periodically updates by the telematics unit.

At 1110, method 1100 includes calculating azimuth and elevation angles from the vehicle to one or more target satellites based on the vehicle parameters determined at 1104, the regional map identified at 1106, and the satellite orbit schedule retrieved at 1108. The one or more target satellites may be selected from the satellites included in the satellite orbit schedule based on comparing the vehicle location and satellite locations. In some examples, the one or more target satellites may be a number (e.g., 1-3) of the closest satellites. In some examples, the one or more target satellites may include each satellite within a threshold distance of the vehicle location.

At 1112, method 1100 includes selecting an antenna from the plurality of antennas based on the calculated azimuth and elevation angles overlapping with the retrieved radiation patterns. Selecting may include determining an amount of overlap of the azimuth and elevation angles with the radiations patterns of each of the plurality of antennas and selecting the antenna corresponding to the largest overlap. For example, the calculated azimuth and elevation angle may correspond to a range stored in a lookup table for the corresponding satellite vendor. The lookup table may indicate which of the antennas communicating at the correct frequency corresponds to the angle range.

In examples where there is one target satellite, one elevation and azimuth angle may be matched to the stored radiation pattern (e.g., the look up table) corresponding to the antenna of the plurality of antennas with the best gain area which is assigned and fixed (e.g., static). In examples where two antennas of the plurality of antennas have overlapping radiation patterns which have a good match to the elevation and azimuth angle, the antenna with the highest gain may be selected.

In some examples, multiple (e.g., more than one) target satellite may be in range of the vehicle and an azimuth and elevation angle may be calculated for each of the multiple target satellites. In such examples, the target satellite of the multiple satellites with elevation and azimuth angles having the highest gain area for one of the plurality of antennas may be selected for linking.

At 1114, method 1100 includes linking to one or more target satellites via the selected antenna. Linking to the satellite may include communicatively coupling the telecom unit to the satellite via the satellite module to enable communication via the satellite link.

At 1116, method 1100 includes predicting and preparing linked satellite and/or antenna handover based on the regional map, vehicle location, orientation, and velocity information. In some examples, a handover may be demanded in if a sharp directional change occurs. A sharp directional change may include a change in direction of over a threshold angle occurring in under a threshold amount of time. The threshold angle may include an angle in the three dimensional sphere of movement of the vehicle. For example, a sharp directional change may occur if the vehicle makes a sharp turn and/or if the vehicle experiences a steep incline or decline. Additionally, a handover may be demanded because a different satellite may be in a better position to link to the vehicle over time. A satellite in a better position may have a higher gain with one of the plurality of antennas than the satellite which is currently linked.

Predicting may include calculating possible azimuth and elevation angles from the vehicle to the one or more target satellites that may occur if the sharp directional change or other possible changes occur as the vehicle and satellite move relative to teach other. Predicting may further include comparing the possible azimuth and elevation angles with the retrieved radiation patterns to select one or more handover antennas.

At 1118, method 1100 determines if a gain of the handover antenna and/or satellite is larger than the gain of the linked antenna. The larger gain may indicate that the handover antenna has a better signal overlap with the current satellite or a new satellite than the current antenna/satellite pair. The gain of the current link and potential links of the handover antenna or antennas may be continuously predicted while the communication link is in progress.

If at 1118, method 1100 determines that gain is not greater, method 1100 proceeds to 1120 and includes maintaining the linked antenna established at step 1114. If at 1118, method 1100 determines that the gain is better, method 1100 proceeds to 1122 and includes switching the linked antenna to the appropriate prepared handover antenna. In this way, the user may not experience a disruption in service upon a sharp change in direction or as the location of satellites change relative to a location of the vehicle. Method 1100 returns.

Turning now to FIG. 16, a flow chart of a method 1600 for selecting an antenna of the plurality of antennas using the NLOS module is shown. As discussed above, the NLOS module may continually monitor a signal quality (e.g., a signal to noise) of the link between the satellite and antenna. Method 1600 may be triggered by the signal quality falling below a threshold, thereby indicating that LOS module no longer adequately predicts the best antenna to link to the satellite.

At 1604, method 1600 includes measuring a signal quality of each antenna link to a currently linked satellite using hardware. For example, a link may be established for each antenna of the plurality of antennas in turn and a quality may be measured using hardware such as SatCom signal quality monitor 1236.

At 1606, method 1600 include linking to the current satellite via the antenna having the best signal quality. The best signal quality may be determined by the measurements of signal quality performed at 1604. For example, the antenna with the best signal quality may be the antenna measured to have the highest signal to noise ratio out of each of the plurality of antennas.

At 1608, method 1600 includes measuring the signal quality of each antenna link to the next satellite. The next satellite may be any other satellite linkable by one of the plurality of antennas. Measuring may be performed by the same hardware used to measure signal quality of the current satellite link as discussed above. Signal quality may be similarly quantified by signal to noise ratio or the like.

At 1610, method 1600 determines if the gain of the current satellite is higher than the gain of the next satellite. For example, each of the measurements at 1604 may be compared to the gain of the current satellite link. If method 1600 determines the gain of the current satellite is higher than the gain of the next satellite, method 1600 proceeds to 1612 and maintains the link between the current satellite and antenna. If method 1600 determines that the gain of the current satellite is not higher than the gain of the next satellite, method 1600 proceeds to 1614 and includes linking to the next satellite via the antenna with the best signal quality. The antenna with the best signal quality may be determined from the measurements at 1608 based on a quantitative measure of signal quality as described above, such as signal to noise ratio. For example, the best signal quality may be the signal with the highest signal to noise ratio. Method 1600 returns.

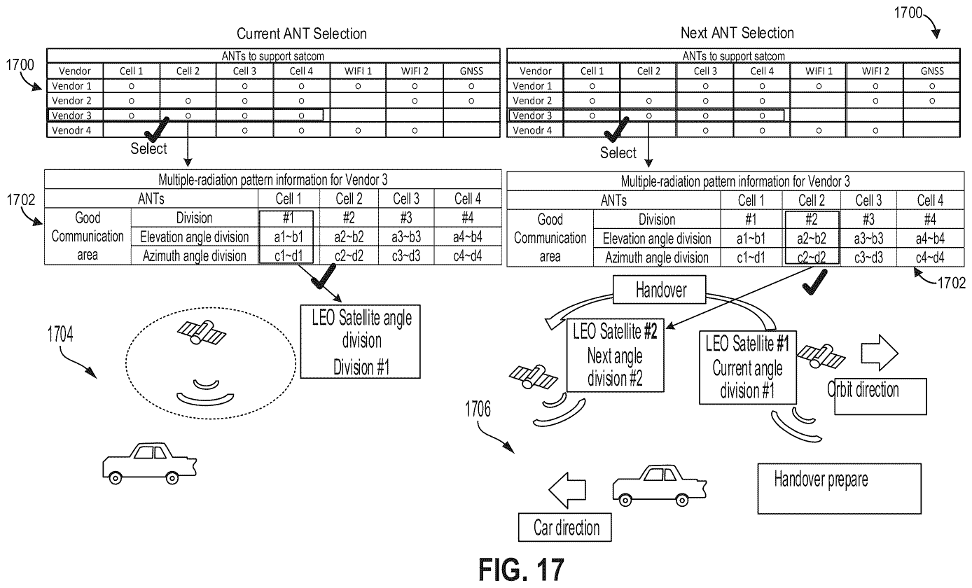

Turning now to FIG. 17 a diagram showing antenna selection and handover is shown. A LOS module, such as the LOS module describe above may use a first table 1700 and a second table 1702 stored in a non-volatile memory of the telematics unit to predict the Cell 1 antenna of the plurality of antennas of the telematics will have the strongest (e.g., highest signal to noise ratio) link to the satellite based on the calculated elevation and azimuth angle being within the ranges associated with Cell1. The vehicle and satellite are shown symbolically in first diagram 1704.

Second diagram 1706 shows an example where the vehicle moves in one direction and satellites move in the opposite direction, moving the first satellite shown in the first diagram away from the vehicle and moving a second satellite towards the vehicle. As described above with respect to method 1100, the elevation angle and azimuth angle from the vehicle to the second satellite may be calculated and used to predict the Cell 2 antenna to have the strongest link to the second satellite. In response to predicting the gain of the link between Cell 1 and first satellite is less than the gain between Cell 2 and the second satellite, handover of communication to the second satellite and Cell 2 may occur. Similarly, the handover may also occur via NLOS module. In examples where antennas are linked by the NLOS module, adjusting may occur in a stepwise fashion as opposed to switching both the satellite and antenna in one decision as with the LOS module. For example, the NLOS module may first determine a link between Cell 3 and satellite 1 has a higher gain than between Cell 1 and Satellite 1, and then determine that link between Cell 2 and Satellite 2 is better (e.g., has a higher gain) than the link between Cell 3 and Satellite 1.

The technical effect of the methods described herein is to decrease a number of antennas included in a telematics unit without sacrificing any communication modes. Decreasing a number of antennas decrease a size, weight, and cost of the telematics unit, Further, decreasing a number of antennas decreases a risk of interference caused coexistence between antenna modules. The methods described herein enable an antenna to communicate in more than one communication mode without sacrificing communication quality.

The disclosure also provides support for a reconfigurable antenna of a telematics unit, comprising: an antenna portion physically coupled to a base, a coupling portion physically coupled to the base, a radiation switch electrically coupled to the coupling portion and configured to switch between electrically coupling to a first short ground and electrically coupling to a first open ground, and a frequency switch electrically coupled to the antenna portion and configured to switch between electrically coupling to a second short ground and electrically coupling to a second open ground. In a first example of the system, the coupling portion is physically spaced away from the antenna portion and configured to reversibly electromagnetically couple to the antenna portion by adjusting the radiation switch. In a second example of the system, optionally including the first example, the antenna portion is a planar inverted F-antenna, and includes a pin portion, a plate portion, and a feed portion. In a third example of the system, optionally including one or both of the first and second examples, the coupling portion overhangs the antenna portion in a plane parallel to the base. In a fourth example of the system, optionally including one or more or each of the first through third examples, the base is a printed circuit board. In a fifth example of the system, optionally including one or more or each of the first through fourth examples, coupling portion is L shaped and includes a parallel plate portion and a perpendicular plate portion relative to the base.

The disclosure also provides support for a method for operating reconfigurable antenna, comprising: in response to determining a cellular network can be searched, actuating a radiofrequency switch to a cellular mode and switching the reconfigurable antenna to a cellular module or to a cellular/satellite hybrid mode based on determining which mode has better signal quality, and in response to determining the cellular network cannot be searched, actuating the radiofrequency switch to a satellite module and switching the reconfigurable antenna to the cellular/satellite hybrid mode or a satellite mode based on determining which mode has better signal quality. In a first example of the method, switching the reconfigurable antenna to the cellular mode include coupling a radiation switch of the reconfigurable antenna to a first open ground and coupling a frequency switch of the reconfigurable antenna to second short ground. In a second example of the method, optionally including the first example, switching the reconfigurable antenna to the cellular/satellite hybrid mode includes coupling a radiation switch of the reconfigurable antenna to a first short ground and coupling a frequency switch of the reconfigurable antenna to a second short ground. In a third example of the method, optionally including one or both of the first and second examples, switching the reconfigurable antenna to the satellite mode includes coupling a radiation switch of the reconfigurable antenna to a first open ground and coupling a frequency switch of the reconfigurable antenna to a second open ground. In a fourth example of the method, optionally including one or more or each of the first through third examples, determining better signal quality includes comparing a signal to noise ratio and/or comparing a received signal strength indicator. In a fifth example of the method, optionally including one or more or each of the first through fourth examples, switching the mode of the reconfigurable antenna adjusts a resonant frequency of the reconfigurable antenna. In a sixth example of the method, optionally including one or more or each of the first through fifth examples, switching the mode of the reconfigurable antenna adjusts a radiation pattern of the reconfigurable antenna.

The disclosure also provides support for a telematics unit of a vehicle, comprising: a plurality of antennas, wherein each of the plurality of antennas is configured to link to a satellite and at least one other communication system, and a processor including instructions stored in non-volatile memory that when executed cause the processor to: link one antenna of the plurality of antennas to the satellite based on a predicted overlap between a stored radiation pattern of the one antenna and a calculated azimuth and elevation angle of the satellite. In a first example of the system, the instructions further comprise to compare a satellite signal strength to a cellular signal strength and handover the link to a cellular module in response to the cellular signal strength being stronger than the satellite signal strength. In a second example of the system, optionally including the first example, the instructions further comprise to link one antenna of the plurality of antennas to the satellite based in measured signal strength in response to a signal quality of the link being below a threshold, wherein the telematics unit includes a SatCom signal quality monitor configured to monitor a satellite signal quality of each of the plurality of antennas. In a third example of the system, optionally including one or both of the first and second examples, the stored radiation pattern includes a lookup table of ranges of elevation angles and ranges of azimuth angles and an antenna of the plurality of antennas corresponding to each of the ranges. In a fourth example of the system, optionally including one or more or each of the first through third examples, the stored radiation pattern includes lookup tables for each vendor of a satellite including antennas of the plurality of antennas corresponding to frequencies supported by each vendor. In a fifth example of the system, optionally including one or more or each of the first through fourth examples, the calculated elevation and azimuth angle of the satellite is based on a satellite orbit schedule and vehicle parameters. In a sixth example of the system, optionally including one or more or each of the first through fifth examples, the vehicle parameters include local time, location, orientation, and vehicle velocity.

In an another representation, the disclosure also provides support for a telematics unit of a vehicle, comprising: a plurality of antennas, and a processor including instructions stored in non-volatile memory that when executed cause the processor to: calculate an azimuth and elevation angle from the vehicle to one or more target satellites based on vehicle parameters, a regional map for a location of the vehicle, and a satellite orbit schedule, select an antenna from the plurality of antennas based on a predicted overlap of the calculated azimuth and elevation angle with stored radiation patterns of the plurality of antennas, and link the one or more target satellites to the selected antenna. In a first example of the system, the instructions further include to predict and prepare a handover antenna and/or satellite based on the vehicle parameters, the regional map, and the satellite orbit schedule. In a second example of the system, optionally including the first example, the handover antenna and/or satellite is predicted and prepared for a sharp change in direction of the vehicle. In a third example of the system, optionally including one or both of the first and second examples, the instructions include to switch the linked antenna to the handover antenna in response to a gain of the handover antenna being greater than a gain of the linked antenna. In a fourth example of the system, optionally including one or more or each of the first through third examples, each antenna of the plurality of antennas is configured to link to a satellite and to link a non-satellite communication module. In a fifth example of the system, optionally including one or more or each of the first through fourth examples, the plurality of antennas does not include an antenna configured to only link to a satellite. In a sixth example of the system, optionally including one or more or each of the first through fifth examples, the satellite orbit schedule includes a vendor, position and velocity of a satellite.

In another representation, the disclosure also provides support for a method of operating a telematics unit of a vehicle, comprising: calculating an azimuth and elevation angle from the vehicle a satellite based on vehicle parameters, a regional map, and a satellite orbit schedule, selecting an antenna from a plurality of antennas based on an overlap of the calculated azimuth and elevation angle with stored radiation patterns of the plurality of antennas, linking the satellite to the selected antenna to form a satellite link, and predicting and preparing a handover antenna and/or satellite. In a first example of the method, the method further includes, monitoring via hardware a signal strength of the satellite link and a signal strength of a cellular signal, and in response to a determining the satellite link strength is not greater than the cellular signal strength, handing over the link to a cellular module of the telematics unit. In a second example of the method, optionally including the first example, the method further includes determining via hardware if a signal quality of the satellite link is greater than a threshold signal quality. In a third example of the method, optionally including one or both of the first and second examples, in response to determining the signal quality of the link is less than the threshold signal quality, measuring a signal quality of each antenna of the plurality of antennas and linking the satellite to antenna of the plurality of antennas having a highest signal quality. In a fourth example of the method, optionally including one or more or each of the first through third examples, selecting the antenna further includes selecting antenna having a frequency overlap with a frequency of the satellite. In a fifth example of the method, optionally including one or more or each of the first through fourth examples, each antenna of the plurality of antennas is configured to link to satellite module and to link a non-satellite communication module.

In another representation, the disclosure also provides support for a telematics unit of a vehicle, comprising: a reconfigurable antenna including a radiation switch configured to switch between coupling to a first short ground and to a first open ground and a frequency switch configured to switch between coupling to a second short ground and to a second open ground, and a processor including instructions stored in non-volatile memory that when executed cause the reconfigurable antenna to: couple the radiation switch to the first open ground and the frequency switch to the second open ground in response to a command to switch to a satellite mode, couple the radiation switch to the first open ground and the frequency switch to the second short ground in response to a command to switch to a cellular mode, and couple the radiation switch to the first short ground and the frequency switch to the second short ground in response to command to switch to a cellular/satellite hybrid mode. In a first example of the system, a peak gain of a radiation pattern of the reconfigurable antenna in the satellite mode is in a zenith direction and a peak gain of a radiation pattern of the reconfigurable antenna in the cellular/satellite hybrid mode is at an angle with respect to the zenith direction. In a second example of the system, optionally including the first example, a resonant frequency of the reconfigurable antenna in satellite mode is in a range of a satellite communication frequency band. In a third example of the system, optionally including one or both of the first and second examples, a resonant frequency of the reconfigurable antenna in cellular mode is in a range of low, mid, and high cellular communication frequency bands. In a fourth example of the system, optionally including one or more or each of the first through third examples, a resonant frequency of the reconfigurable antenna in cellular/satellite hybrid mode is in a range of a satellite communication frequency band and within a range of a cellular communication frequency band. In a fifth example of the system, optionally including one or more or each of the first through fourth examples, the reconfigurable antenna includes a PIFA type antenna, a coupling plate, and a base coupled to the PIFA type antenna and the coupling plate. In a sixth example of the system, optionally including one or more or each of the first through fifth examples, the system further comprises: a radiofrequency switch configured to switch between a SatCom module and a cellular module.

FIGS. 4-5, 7, and 13 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 4-5 and 7 are drawn approximately to scale, although other dimensions or relative dimensions may be used.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the telematics unit 30 described with reference to FIG. 1. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A reconfigurable antenna of a telematics unit, comprising:
an antenna portion physically coupled to a base;
a coupling portion physically coupled to the base;
a radiation switch electrically coupled to the coupling portion and configured to switch between electrically coupling to a first short ground and electrically coupling to a first open ground; and
a frequency switch electrically coupled to the antenna portion and configured to switch between electrically coupling to a second short ground and electrically coupling to a second open ground.

2. The reconfigurable antenna of claim 1, wherein the coupling portion is physically spaced away from the antenna portion and configured to reversibly electromagnetically couple to the antenna portion by adjusting the radiation switch.

3. The reconfigurable antenna of claim 1, wherein the antenna portion is a planar inverted F-antenna, and includes a pin portion, a plate portion, and a feed portion.

4. The reconfigurable antenna of claim 1, wherein the coupling portion overhangs the antenna portion in a plane parallel to the base.

5. The reconfigurable antenna of claim 1, wherein the base is a printed circuit board.

6. The reconfigurable antenna of claim 1, wherein coupling portion is L shaped and includes a parallel plate portion and a perpendicular plate portion relative to the base.

7. A method for operating a reconfigurable antenna, comprising:
in response to determining a cellular network can be searched, actuating a radiofrequency switch to a cellular mode and switching the reconfigurable antenna to a cellular module or to a cellular/satellite hybrid mode based on determining which mode has better signal quality; and
in response to determining the cellular network cannot be searched, actuating the radiofrequency switch to a satellite module and switching the reconfigurable antenna to the cellular/satellite hybrid mode or a satellite mode based on determining which mode has better signal quality.

8. The method of claim 7, wherein switching the reconfigurable antenna to the cellular mode includes coupling a radiation switch of the reconfigurable antenna to a first open ground and coupling a frequency switch of the reconfigurable antenna to second short ground.

9. The method of claim 7, wherein switching the reconfigurable antenna to the cellular/satellite hybrid mode includes coupling a radiation switch of the reconfigurable antenna to a first short ground and coupling a frequency switch of the reconfigurable antenna to a second short ground.

10. The method of claim 7, wherein switching the reconfigurable antenna to the satellite mode includes coupling a radiation switch of the reconfigurable antenna to a first open ground and coupling a frequency switch of the reconfigurable antenna to a second open ground.

11. The method of claim 7, wherein determining better signal quality includes comparing a signal to noise ratio and/or comparing a received signal strength indicator.

12. The method of claim 7, wherein switching the reconfigurable antenna adjusts a resonant frequency of the reconfigurable antenna.

13. The method of claim 7, wherein switching the reconfigurable antenna adjusts a radiation pattern of the reconfigurable antenna.

14. A telematics unit of a vehicle, comprising:
a plurality of antennas, wherein each of the plurality of antennas is configured to link to a satellite and at least one other communication system; and
a processor including instructions stored in non-volatile memory that when executed cause the processor to:
link one antenna of the plurality of antennas to the satellite based on a predicted overlap between a stored radiation pattern of the one antenna and a calculated azimuth and elevation angle of the satellite.

15. The telematics unit of claim 14, wherein the instructions further cause the processor to compare a satellite signal strength to a cellular signal strength and handover the link to a cellular module in response to the cellular signal strength being stronger than the satellite signal strength.

16. The telematics unit of claim 15, wherein the instructions further comprise to link one antenna of the plurality of antennas to the satellite based on measured signal strength in response to a signal quality of the link being below a threshold, wherein the telematics unit includes a SatCom signal quality monitor configured to monitor a satellite signal quality of each of the plurality of antennas.

17. The telematics unit of claim 14, wherein the stored radiation pattern includes a lookup table of ranges of elevation angles and ranges of azimuth angles and an antenna of the plurality of antennas corresponding to each of the ranges.

18. The telematics unit of claim 17, wherein the stored radiation pattern includes lookup tables for each vendor of the satellite including antennas of the plurality of antennas corresponding to frequencies supported by each vendor.

19. The telematics unit of claim 14, wherein the calculated azimuth and elevation angle of the satellite is based on a satellite orbit schedule and vehicle parameters.

20. The telematics unit of claim 19, wherein the vehicle parameters include local time, location, orientation, and vehicle velocity.
